(19) United States
(12) Patent Application Publication
(10) Pub. No.: US 2019/0199139 A1
(43) Pub. Date: Jun. 27, 2019

(54) COORDINATED WIRELESS POWER TRANSFER

(71) Applicant: UBEAM INC., Santa Monica, CA (US)

(72) Inventor: MEREDITH PERRY, Beverly Hills, CA (US)

(21) Appl. No.: 15/851,132

(22) Filed: Dec. 21, 2017

(51) Int. Cl. H02J 50/40; H02J 50/15; H02J 50/30; H02J 50/12; H02J 7/02

(52) U.S. Cl. CPC H02J 50/40; H02J 50/15; H02J 7/025; H02J 50/12; H02J 50/30

(57) ABSTRACT

A transmitter device may include first and second transmitter wireless power transfer devices that respectively may use a first and second type of wireless power transfer that are different from each other, and a controller connected to the first and second transmitter wireless power transfer devices that may control the transmission of wireless power from the first and second wireless power transfer devices. A receiver device may include first and second receiver wireless power transfer devices that may use the first and second type of wireless power transfer, respectively, and may generate a first and second electrical signal based on a transfer of wireless power using the first and second type of wireless power transfer from the first and second transmitter wireless power transfer devices. The receiver device may also include an electrical storage device that may store electrical energy based on the first and second electrical signal.

### BACKGROUND

Devices that require energy to operate can be plugged into a power source using a wire. This can restrict the movement of the device and limit its operation to within a certain maximum distance from the power source. Even most battery-powered devices must periodically be tethered to a power source using a cord, which can be inconvenient and restrictive.

Wireless charging can be used to allow a device to be charged without requiring that the device be connected directly to a power source by a wire. There are various ways in which a device can be charged wirelessly, and these ways have varying ranges over which they can deliver power wirelessly, varying rates at which power can be delivered wirelessly, and varying line-of-sight requirements.

### BRIEF SUMMARY

According to an embodiment of the disclosed subject matter, a transmitter device may include a first transmitter wireless power transfer device that may use a first type of wireless power transfer, a second transmitter wireless power transfer device that may use a second type of wireless power transfer different from the first type of wireless power transfer, and a controller coupled to the first transmitter wireless power transfer device and the second transmitter wireless power transfer device that may control the transmission of wireless power from the first wireless power transfer device and the second wireless power transfer device.

A receiver device may include a first receiver wireless power transfer device that may use the first type of wireless power transfer and may generate a first electrical signal based on a transfer of wireless power using the first type of wireless power transfer from the first transmitter wireless power transfer device, a second receiver wireless power transfer device that may use the second type of wireless power transfer and may generate a second electrical signal based on a transfer of wireless power using the second type of wireless power transfer from the second transmitter wireless power transfer device, and a receiver electrical storage device that may store electrical energy based on the first electrical signal generated by the first receiver wireless power transfer device and the second electrical signal generated by the second wireless power transfer device.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A shows an exemplary system in accordance with the disclosed subject matter.

FIG. 1B shows an exemplary system in accordance with the disclosed subject matter.

FIG. 2A shows an exemplary device in accordance with the disclosed subject matter.

FIG. 2B shows an exemplary device in accordance with the disclosed subject matter.

FIG. 3A shows an exemplary arrangement in accordance with the disclosed subject matter.

FIG. 3B shows an exemplary arrangement in accordance with the disclosed subject matter.

FIG. 3C shows an exemplary arrangement in accordance with the disclosed subject matter.

FIG. 4A shows an exemplary arrangement in accordance with the disclosed subject matter.

FIG. 4B shows an exemplary arrangement in accordance with the disclosed subject matter.

FIG. 4C shows an exemplary arrangement in accordance with the disclosed subject matter.

FIG. 5 shows an exemplary procedure in accordance with the disclosed subject matter.

FIG. 6 shows an exemplary procedure in accordance with the disclosed subject matter.

FIG. 7 shows a computer according to an embodiment of the disclosed subject matter.

FIG. 8 shows a network configuration according to an embodiment of the disclosed subject matter.

### DETAILED DESCRIPTION

According to embodiments disclosed herein, electrical energy may be converted into types of energy which may be delivered to a device wirelessly. The device may convert the delivered energy back into electrical energy. The converted electrical energy may be used to power the device and to charge one or more energy storage components of the device, such as a battery, a capacitor, etc. This can obviate the need for constant or periodic tethering to a power source using a cord. A transmitter device which delivers energy wirelessly may be able to deliver multiple types of wireless energy, either at the same time, or in the alternative. The transmitter device may coordinate the delivery of different types of wireless energy using different wireless energy transmitters. Energy may be transferred to several devices at once, in rotation or in any suitable sequence, with dwell times of any suitable duration.

A transmitter device may receive electrical energy from a power source, such as an electrical outlet or a battery. The transmitter device may include a signal generator, which may generate a signal that may be amplified by an amplifier using the electrical energy from the power source. The amplified signal may be sent to an ultrasonic transducer array. The ultrasonic transducer array may be an array of any number of any suitable types of ultrasonic transducers, arranged in any suitable manner as part of the transmitter device. The ultrasonic transducer array may convert the signal from the amplifier, which may be an electrical signal, into ultrasonic energy, which may be emitted in the form of ultrasound waves that may be transmitted through a medium such as the air. The transmitter device may include a controller, which may control the emission of ultrasonic waves from the ultrasonic transducer array, for example, controlling the phase and frequency of ultrasonic waves from the ultrasonic transducers that make up the ultrasonic transducer array to control the steering and focus of ultrasonic beams formed by the ultrasonic waves.

The transmitter device may include a second wireless power transfer device in addition to the ultrasonic transducer array. For example, the transmitter device may include a magnetic resonance power transmitter as a second wireless power transfer device. The magnetic resonance power transmitter may include, for example, a wire coil near a surface of the transmitter device and a controller. A signal generator may generate a signal which may be amplified by an amplifier using the electrical energy from the power source. The amplified signal, which may be an electrical signal, may be sent to the wire coil, which may generate an oscillating magnetic field through induction via changes in the electrical field generated by the amplified signal flowing through the wire coil. The oscillating magnetic field may be able to induce electrical current in another wire coil that is located within the magnetic field. The controller of the transmitter device may control the induction of the magnetic field by the wire coil, for example, changing the frequency of oscillation of the magnetic field so that it operates in a resonance with another wire coil. The signal generator and the amplifier used with the magnetic resonance power transmitter may be the same as the signal generator and the amplifier used with the ultrasonic transducer array, or may be a separate signal generator and amplifier.

As another example, the transmitter device may include an infrared laser power transmitter as a second wireless power transfer device. The infrared laser power transmitter may include, for example, any suitable number of infrared lasers arranged in any suitable manner. A signal generator may generate a signal which may be amplified by an amplifier using the electrical energy from the power source. The amplified signal, which may be an electrical signal, may be sent to infrared lasers, which may generate infrared light. The controller of the transmitter device may control the generation of infrared light by the infrared lasers, for example, changing the frequency and phase of the infrared light generated by various infrared lasers. The signal generator and the amplifier used with the infrared laser power transmitter may be the same as the signal generator and the amplifier used with the ultrasonic transducer array, or may be a separate signal generator and amplifier.

A receiver device may include a receiver transducer array, which may include any suitable number of any suitable type of ultrasonic transducers arranged in any suitable manner. The receiver transducer array may receive ultrasonic waves, such as those generated by ultrasonic transducer array of the transmitter device, and convert the ultrasonic waves to electrical energy. The electrical energy generated by the receiver transducer array may be used to charge an energy storage device or power a processor of the receiver device. The energy storage device may be, for example, a battery, a capacitor, an induction circuit, or any other suitable device for storing electrical energy. The receiver device may be, for example, a smartphone, a portable computer, an electronic content reader, a tablet, a display, a TV, or any other suitable electronic device. The receiver device may include a controller which may control the usage of electrical energy generated by the receiver transducer array.

The receiver device may also include a second wireless power transfer device in addition to the receiver transducer array. For example, the receiver device may include a magnetic resonance power receiver as a second wireless power transfer device. The magnetic resonance power receiver may include, for example, a wire coil near a surface of the receiver device. For example, the wire coil may be embedded in the receiver device behind the ultrasonic transducers of the receive transducer array, as the ultrasonic transducers may be positioned on the surface of the receiver device. When the receiver device is within a suitable distance of an oscillating magnetic field, for example, as created by the wire coil of a magnetic resonance power transmitter of the transmitter device, electrical current may be induced in the wire coil of the magnetic resonance power receiver of the receiver device, generating electrical energy. The electrical energy generated by the wire coil of the magnetic resonance power receiver may be used to charge an energy storage device or power a processor of the receiver device. A controller of the receiver device, which may be the same controller used with the receiver transducer array, may control the usage of electrical energy generated by the magnetic resonance power receiver.

As another example, the receiver device may include a photo-voltaic array as a second wireless power transfer device. The photo-voltaic array may include, for example, any suitable number of photo-voltaic devices arranged in any suitable manner. The photo-voltaic devices of the photo-voltaic array may receive infrared light, such as the infrared light generated by the infrared lasers of the transmitter device, and convert the infrared light to electrical energy. The electrical energy generated by the photo-voltaic array may be used to charge an energy storage device or power a processor of the receiver device. The energy storage device may be, for example, a battery, a capacitor, an induction circuit, or any other suitable device for storing electrical energy. A controller of the receiver device, which may be the same controller used with the receiver transducer array, may control the usage of electrical energy generated by the photo-voltaic array.

The transmitter device may be in communication with receiver devices, for example, through any suitable form of wireless communication. The transmitter device may also be able to determine the locations and orientations of receiver devices in any suitable manner, using any suitable data. For example, receiver devices may send location and orientation data to the transmitter device, and the transmitter device may use, for example, cameras for visible and infrared light, radar, Lidar, ultrasonic object tracking, or any other suitable form of object tracking, to determine the location and orientation of receiver devices. The receiver devices may also include, for example, infrared reflectors which may allow for tracking with an infrared camera.

The transmitter device may coordinate the usage of different wireless power transfer devices to deliver wireless power to receiver devices. For example, the transmitter device may include an ultrasonic transducer array and a magnetic resonance power transmitter, and receiver devices may include receiver transducer arrays and magnetic resonance power receivers. The transmitter device may determine which wireless power transfer device to use to deliver wireless power to a receiver device based on the location of the receiver device relative to the wireless power transfer devices of the transmitter device. For example, when a receiver device is within a specified distance of the wire coil of the magnetic resonance power transmitter, the transmitter device may activate the magnetic resonance power transmitter to deliver wireless power to the receiver device through an oscillating magnetic field. The specified distance may be based on the effective range over which the oscillating magnetic field generated by the magnetic resonance power transmitter can induce a usable amount of current in a wire coil and may be, for example, 50 cm from the location of the wire coil of the magnetic resonance power transmitter.

The transmitter device may also reduce the wireless power sent to a receiver device using the ultrasonic transducer array when the magnetic resonance power transmitter is activated and the receiver device begins using electrical energy from its magnetic resonance power receiver, for example, to charge an energy storage device or power components of the receiver device. The receiver device may, for example, communicate to the transmitter device the amount of power the receiver device is generating from its magnetic resonance power receiver, or from both its magnetic power receiver and receiver transducer array. The transmitter device may use the power data from the receiver device to determine an amount by which to reduce the power being delivered to the receiver transducer array of the receiver device. For example, the receiver device may communicate a power requirement to the transmitter device. If the total amount of power being received by the receiver from the magnetic resonance power transmitter and the ultrasonic transducer array exceeds the power requirement of the receiver device, the transmitter device may reduce the amount of power sent to the receiver device by the ultrasound transducer array until the total amount of power matches the power requirement.

The reduction of power sent to the receiver device by ultrasonic transducer array may be accomplished in any suitable manner. For example, the transmitter device may use any combination of reducing the number of ultrasonic transducers being used to send ultrasonic waves to the receiver device, reducing the amplitude of the ultrasonic waves generated by the ultrasonic transducers that are sending ultrasonic waves to the receiver device, and reducing the dwell time of ultrasonic transducers on the receiver device. For example, to reduce the number of ultrasonic transducers being used to send ultrasonic waves to the receiver device, a number of the ultrasonic transducers may be switched off, or the ultrasonic beam created by the ultrasonic waves from a number of ultrasonic transducers may be steered in a direction away from the receiver device, for example, towards another receiver device. Dwell time may be reduced by, for example, switching a number of the ultrasonic transducers off and on, or by alternately directing an ultrasonic beam away from the receiver device for a period of time, and then back to the receiver device for a period of time. This may reduce the power the receiver device receives from ultrasonic waves generated by the ultrasonic transducer array when sufficient power is being supplied to the receiver device by the magnetic resonance power transmitter.

The transmitter device may also stop supplying any power to the receiver device using the ultrasonic transducer array if there is no line-of-sight between any of the ultrasonic transducers of the ultrasonic transducer array and the ultrasonic transducers of the receiver transducer array. For example, the receiver device may be at an oblique angle to the transmitter device. The transmitter device may increase the amount of electrical energy supplied to the magnetic resonance power transmitter in order to increase the amount of power delivered to the receiver device through the magnetic resonance power receiver to compensate for no power being delivered using ultrasonic waves.

When a receiver device that was within a specified distance of the wire coil of the magnetic resonance power transmitter and was receiving power from the magnetic resonance power transmitter starts moving away from the wire coil, the transmitter device may deliver more power to the receiver device using the ultrasonic transducer array. The transmitter device may also reduce wireless power sent to the receiver device using the magnetic resonance power transmitter as the receiver device moves away from the wire coil. For example, the transmitter device may determine that the receiver device is moving away from the wire coil, for example, based on location data received from the receiver device, tracking of the receiver device, or an indication from the receiver device the amount of power the receiver device is generating from its magnetic resonance power receiver, or from both its magnetic resonance power receiver and receiver transducer array, is decreasing or has decreased to a specified level. The transmitter device may initiate a handoff from the magnetic resonance power transmitter to the ultrasound transmitter array by increasing the power the ultrasound transmitter array delivers to the receiver device and reducing the power the magnetic resonance power transmitter delivers to the receiver device, for example, reducing power to the magnetic resonance power transmitter if there are no other receiver devices within the specified distance of the wire coil of the magnetic resonance power transmitter.

The reduction of power sent to the receiver device by the magnetic resonance power transmitter may be accomplished by, for example, the reduction of electrical energy supplied to the magnetic resonance power transmitter by the transmitter device. The magnetic resonance power transmitter may be deactivated once the receiver device has moved outside of the specified distance. If the magnetic resonance power transmitter is sending power to other receiver devices, the electrical energy provided to the magnetic resonance power transmitter may not be reduced, and the magnetic resonance power transmitter may remain active even as the receiver device moves outside the specified distance.

The increase in power sent to the receiver device by the ultrasound transducer array may be accomplished in any suitable manner. For example, the transmitter device may use any combination of increasing the number of ultrasonic transducers being used to send ultrasonic waves to the receiver device, increasing the amplitude of the ultrasonic waves generated by the ultrasonic transducers that are sending ultrasonic waves to the receiver device, and increasing the dwell time of ultrasonic transducers on the receiver device. For example, to increase the number of ultrasonic transducers being used to send ultrasonic waves to the receiver device, a number of the ultrasonic transducers may be switched on, or the ultrasonic beam created by the ultrasonic waves from a number of ultrasonic transducers may be steered in a direction towards the receiver device. Dwell time may be increased by, for example, switching a number of the ultrasonic transducers off and on so that they remain on for longer periods of time, or by alternately directing an ultrasonic beam towards the receiver device for longer periods of time. This may increase the power the receiver device receives from ultrasonic waves generated by the ultrasonic transducer array as the receiver device moves away from the magnetic resonance power transmitter and consequently receives less power from that magnetic resonance power transmitter.

As another example, the transmitter device may include an ultrasonic transducer array and an infrared laser power transmitter, and receiver devices may include receiver transducer arrays and photo-voltaic arrays. The transmitter device may determine which wireless power transfer device to use to deliver wireless power to a receiver device based on the location of the receiver device relative to the wireless power transfer devices of the transmitter device, and on the proximity of any persons or animals to otherwise clear lines-of-sight between the photo-voltaic arrays of the receiver device and infrared lasers of the infrared laser power transmitter. For example, when there is a clear line-of-sight between the photo-voltaic arrays of the receiver device, with no people or animals in the vicinity of the line-of-sight, the transmitter device may activate the infrared laser power transmitter to deliver wireless power to the receiver device through infrared light generated by the infrared lasers. The transmitter device may determine that the line-of-sight is clear with no people or animals proximate to the line-of-sight in any suitable manner. For example, the transmitter device may use a camera of any suitable type, such as an infrared camera, radar, LIDAR, or any other suitable device for locating and identifying the location of people and animals within an environment, as well objects that may block the line-of-sight.

The transmitter device may use the infrared laser power transmitter to supplement the power being supplied to the receiver device by the ultrasound transducer array. For example, when the transmitter device starts transmitting power to the receiver device using the infrared laser power transmitter while the ultrasound transducer array is also transmitting power to the receiver device, the ultrasound transducer array may continue to transmit power to the receiver device without reduction when the receiver device has indicated it needs a large amount of power. For example, the receiver device may communicate to the transmitter device that the receiver device has low level of electrical energy stored in its energy storage device. The infrared laser power transmitter may use a lower level of electrical energy to power the infrared lasers, supplementing the power provided by the ultrasonic transducer array.

The transmitter device may also reduce the wireless power sent to the receiver device using the ultrasonic transducer array when the infrared laser power transmitter is activated and the receiver device begins using electrical energy from its photo-voltaic array, for example, to charge an energy storage device or power components of the receiver device. The receiver device may, for example, communicate to the transmitter device the amount of power the receiver device is generating from its photo-voltaic arrays, or from both its photo-voltaic array and receiver transducer array. The transmitter device may use the power data from the receiver device to determine an amount by which to reduce the power being delivered to the receiver transducer array of the receiver device. For example, the receiver device may communicate a power requirement to the transmitter device. If the total amount of power being received by the receiver from the infrared laser power transmitter and the ultrasonic transducer array exceeds the power requirement of the receiver device, the transmitter device may reduce the amount of power sent to the receiver device by the ultrasound transducer array until the total amount of power matches the power requirement.

The transmitter device may also stop supplying any power to the receiver device using the ultrasonic transducer array when the receiver device is positioned such that the ultrasonic transducers of the receiver transducer array are at an oblique angle to the ultrasonic transducers of the ultrasonic transducer array. The transmitter device may stop using the ultrasonic transducer array to transmit power to the receiver device, for example, deactivating the ultrasonic transducer array, or directing ultrasonic beams generated by the ultrasonic transducer array towards other receiver devices. The transmitter device may increase the amount of electrical energy supplied to the infrared laser power transmitter in order to increase the amount of power delivered to the receiver device through the photo-voltaic array to compensate for no power being delivered using ultrasonic waves.

When a person or animal enters or comes within a specified proximity of the line-of-sight between the photo-voltaic array of the receiver device and the infrared laser power transmitter while it is sending power to the receiver device, the transmitter device may deactivate, or redirect the infrared light from, the infrared laser power transmitter. For example, the receiver device may be picked up and handled by a person, or a person may walk in-between the receiver device and the transmitter device. Any infrared lasers of the infrared laser power transmitter that were delivering power to the receiver device may either be shut off, or may be redirected towards other receiver devices to which there is a clear line-of-sight. The electrical energy provided to the infrared laser power transmitter may be reduced by the transmitter device if the infrared laser power transmitter is deactivated, or may be maintained if the infrared lasers are redirected. The infrared lasers that are redirected away from the receiver device may be deactivated temporarily during redirection before being turned back on when they are directed at the photo-voltaic array of a different receiver device. The transmitter device may deliver more power to the receiver device using the ultrasonic transducer array if the amount of power being delivered by the ultrasonic transducer array was reduced while the infrared laser power transmitter was transmitting power to the receiver device.

Coordination of different wireless power transfer devices by the transmitter device may allow for a more continuous supply of wireless power to a receiver device. Additionally, more power may be supplied to a given receiver device, and the transmitter device may be able to supply power to more receiver devices at different locations and orientations relative to the transmitter device. The wireless power transfer devices may have individual controllers within the transmitter device, and those individual controllers may be subordinate to a master controller which may coordinate the usage of the different wireless power transfer devices. In some implementations, the transmitter device may include more than two wireless power transfer devices. For example, the transmitter device may include an ultrasonic transducer array, a magnetic resonance power transmitter, and an infrared laser power transmitter.

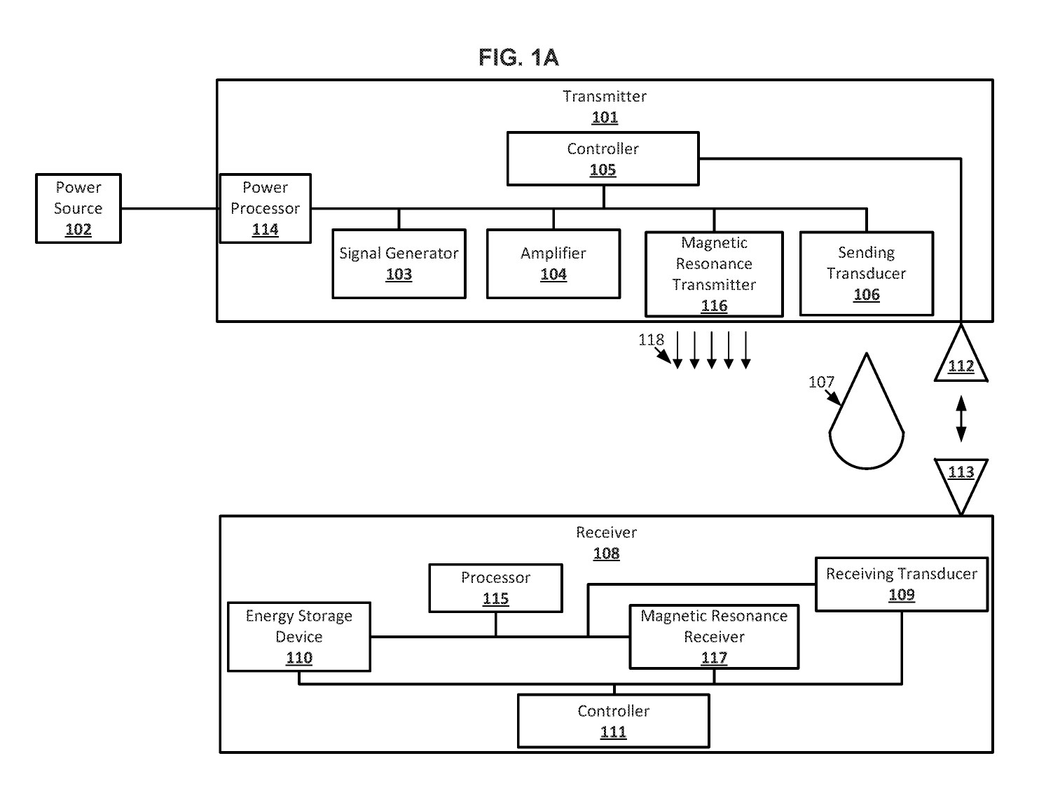

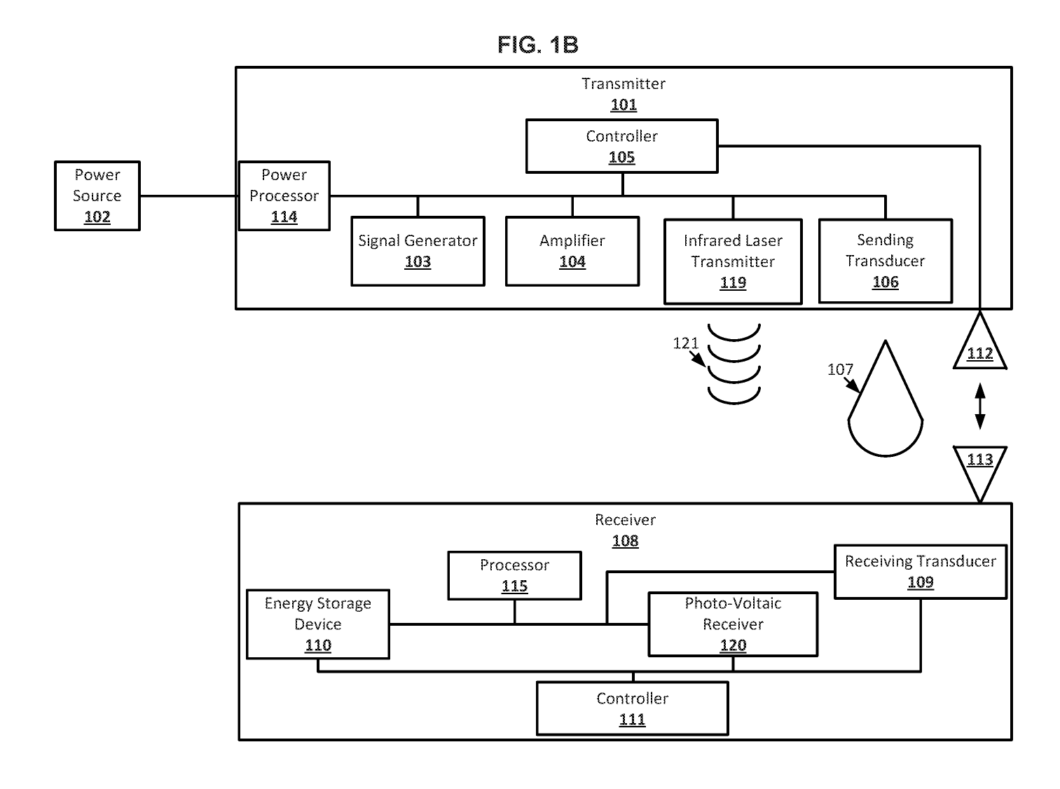

FIG. 1A shows an exemplary system in accordance with the disclosed subject matter. Transmitter 101 may be a transmitter device for transmitting wireless power. The transmitter 101 may receive electrical energy from power source 102 (such as an electrical outlet or a battery) as input. Signal generator 103 may generate a signal that can be amplified by amplifier 104. This can be done under the control of transmitter controller 105. The amplified signal may be sent to sending transducer 106, which may be an ultrasonic transducer array including any suitable number of ultrasonic transducers. The sending transducer 106 may generate ultrasonic energy in the form of ultrasound waves 107 may be transmitted through a medium such as the air. Receiver 108 may include a receiving transducer 109, which may be a receiver transducer array including any suitable number of ultrasonic transducers in any suitable arrangement. The receiver 108 may receive ultrasonic energy in the form of ultrasonic waves at the receiving transducer 109, which may convert the ultrasound waves 107 to electrical energy. The electrical energy generated by the receiving transducer 109 may be used to charge energy storage device 110 or power processor 111. For example, the ultrasound transducers may generate alternating current which may be converted into direct current before or after being output from the receiving transducer 109. Examples of energy storage device 110 may include a battery, a capacitor, an induction circuit, etc. Examples of receiver 108 may include a smartphone, a portable computer, an electronic content reader, a TV, or any other electronic device. Receiver controller 111 may control the receiving transducer 109 and/or energy storage device 110.

The transmitter 101 may also include a magnetic resonance transmitter 116. The magnetic resonance transmitter 116 may be any suitable magnetic resonance power transmitter, including any suitable number of wire coils arranged in any suitable manner. The magnetic resonance transmitter 116 may receive electrical energy from any suitable source. For example, the magnetic resonance transmitter 116 may receive an amplified signal from the amplifier 104, or from other suitable components of the transmitter 101. The amplified signal received at the magnetic resonance transmitter 116 may be based on a signal from the signal generator 103 separate from the signal used by the sending transducer 106, or may be based on a signal from a signal generator incorporated into the magnetic resonance transmitter 116. The magnetic resonance transmitter 116 may also receive power directly, for example, from a power processor 114 of the transmitter 101, and may generate and amplify signals using its own electrical and electronic components separate from the signal generator 103 and the amplifier 104. The magnetic resonance transmitter 116 may generate an oscillating magnetic field 118, which may be able to induce electrical current in conductors that pass through the oscillating magnetic field 118.

The receiver 108 may include a magnetic resonance receiver 117. The magnetic resonance receiver 117 may be a magnetic resonance power receiver, which may include any suitable number of wire coils arranged in any suitable manner. The wire coils of the magnetic resonance receiver 117 may be located in any suitable location on the receiver 108, such as, for example, near a surface of the receiver 108 behind ultrasonic transducers of the receiving transducer 109. When the receiver 108 is close enough to the transmitter 101, the magnetic resonance receiver 117 may close enough to the oscillating magnetic field 118 to induce current in wire coils of the magnetic resonance receiver 117. The induced current in the wire coils of the magnetic resonance receiver 117 may be used as electrical energy by the receiver 108, for example, to charge energy storage device 110 or power processor 111. The range over which the oscillating magnetic field 118 can induce current in the wire coils of the magnetic resonance receiver 117 may be extended through resonance between the wire coils of the magnetic resonance receiver 117 and the wire coils of the magnetic resonance transmitter 116 as mediated through the oscillating magnetic field 118.

The transmitter 101 may include a transmitter controller 105. The transmitter controller 105 may control and coordinate the magnetic resonance transmitter 116 and the sending transducer 106. For example, the transmitter controller 105 may be a master controller which may control subordinate controllers of the magnetic resonance transmitter 116 and the sending transducer 106, or the transmitter controller 105 may control both the magnetic resonance transmitter 116 and the sending transducer 106 directly. The transmitter controller 105 may, for example, activate and deactivate the magnetic resonance transmitter 116 based on the distance between the transmitter 101 and a receiver such as the receiver 108. The transmitter controller 105 may activate, deactivate, and steer ultrasonic beams generated by the ultrasonic transducers 106 based on the location and orientations of receivers such as the receiver 108 relative to the transmitter 101, and on power data from receivers. The transmitter controller 105 may be coupled to antenna 112 and the receiver controller 111 of the receiver may be coupled to antenna 113. As described below, the transmitter controller 105 and receiver controller 111 may communicate through antennas 112 and 113.

The sending transducer 106 may include any suitable number of ultrasonic transducers arranged in an any suitable manner, such as in an array, that may produce a focused beam of ultrasonic energy from ultrasonic soundwaves. The sending transducer 106 may include at least one Capacitive Micro machined Ultrasonic Transducer (CMUT), a Capacitive Ultrasonic Transducer (CUT), an electrostatic transducer or any other transducer suitable for converting electrical energy into acoustic energy. To generate focused ultrasonic energy via a phased array, the sending transducer 106 may include a timed delay transducer or a parametric array transducer, or a bowl-shaped transducer array. The sending transducer 106 may operate for example between about 20 to about 120 kHz for transmission of ultrasonic energy through air, and up to about 155 dB, for example. For ultrasonic transmission through other mediums, the transmitter 101 can operate at frequencies greater than or equal to 1 MHz, for example. The sending transducer 106 may have a high electromechanical conversion, for example an efficiency of about 40%, corresponding to about a 3 dB loss.

The transmitter controller 105 may cause the sending transducer 106 to emit ultrasonic waves based on the proximity of the sending transducer 106 (or the transmitter 101 in general) to the receiving transducer 109. The receiving transducer 109 may convert ultrasonic energy received from the sending transducer 106 to electrical energy. As used herein, proximity can be the actual or effective distance between the sending transducer 106 or the like and the receiving transducer 109 or the like. Effective distance can be based on the efficiency of energy transmission between sending transducer the 106 and receiving transducer 109 based on various factors that can include, without limitation, their relative locations; the characteristics of the conductive medium (e.g., the air, tissue, etc.) between transmitter and receiver; the relative orientation of the transmitter and receiver; obstructions that may exist between the transmitter and receiver; relative movement between transmitter and receiver; etc. In some cases, a first transmitter/receiver pair may have a higher proximity than a second transmitter/receiver pair, even though the first pair is separated by a greater absolute distance than the second pair.

The transmitter controller 105 may cause a beam of ultrasonic energy to be directed toward receiving transducer 109. Further, the transmitter controller 105 may cause the sending transducer 106 to emit ultrasonic waves having at least one frequency and at least one amplitude.

The transmitter controller 105 may cause the sending transducer 106 to change the frequency and/or amplitude of at least some of the ultrasonic waves based on the proximity and/or location of the sending transducer 106 to the receiving transducer 109. Additionally, the transmitter controller 105 may cause the sending transducer 106 to change the amplitude of at least some of the ultrasonic waves based on the frequency of the ultrasonic energy emitted by sending transducer or based on information regarding the receipt of ultrasonic energy as determined by the receiver controller 111.

The transmitter controller 105 and the receiver controller 111 of the receiver 108 may communicate through antennas 112 and 113. In this way, the receiver controller 111 may be able to control the character and amplitude of the energy generated by the sending transducer 106 by sending commands to the transmitter controller 105. Also, the transmitter controller 105 may control the characteristics of sending transducer 106 based upon data and/or commands received from the receiver controller 111. Likewise, the transmitter controller 105 may control the characteristics of the energy sent by the sending transducer 106 independently of input from the receiver controller 111.

The transmitter controller 105 may include a transmitter communications device (not shown) that may send an interrogation signal to detect the receiving transducer 109. The transmitter communications device may send a control signal to a receiver communications device (not shown) coupled to the receiver controller 111. The receiver controller 111 may control the receiving transducer 109. The control signal may include the frequency and/or amplitude of the ultrasonic energy emitted by the sending transducer 106. The control signal can be used to determine the proximity and/or orientation of the sending transducer 106 to the receiving transducer 109. Additionally, the control signal may include an instruction to be executed by the receiver controller 111 and may also include information about the impedance of the sending transducer 106.

The sender communication device may receive a control signal from the receiver communication device, which may be in communication with the receiver controller 111. The control signal may include a desired power level, the frequency and/or amplitude of ultrasonic energy received from the sending transducer 106. Additionally, the control signal may include the impedance of the receiving transducer 109, a request for power, and/or an instruction to be executed by the transmitter controller 105. The control signal may be used to determine the proximity of the sending transducer to the receiver transducer and/or the relative orientation of the sending transducer to the receiver transducer. Further, the control signal may also indicate a power status. Such a power status may indicate, for example, the amount of power available to the receiver 108, e.g., percent remaining, percent expended, amount of joules or equivalent left in the receiver energy storage device 110. The control signal may be transmitted by modulating at least some of the ultrasonic waves and/or may be transmitted out-of-band, e.g., using a separate radio frequency transmitter, or by sending a signal through a cellular telephone network or via a Wi-Fi network. For example, the signal may be transmitted by text, instant message, email, etc.

The transmitter 101 may further include the signal generator 103, variously known as a function generator, pitch generator, arbitrary waveform generator, or digital pattern generator, which can generate one or more waveforms of ultrasonic waves. The transmitter controller 105 can itself include an oscillator, an amplifier, a processor, memory, etc., (not shown.) The processor of the transmitter controller 105 may also execute instructions stored in memory to produce specific waveforms using the signal generator 103. The waveforms produced by the signal generator 103 may be amplified by the amplifier 104. The transmitter controller 105 may regulate how and when the sending transducer 106 may be activated. The signal generator 103 may also generate signal for the magnetic resonance transmitter 116, for example, to control the oscillation of the oscillating magnetic field 118 in order to achieve resonance between the magnetic resonance transmitter 116 and the magnetic resonance receiver 117.

The electrical power source 102 for transmitter 101 may be an AC or DC power source. Where an AC power source is used, transmitter 101 may include the power processor 114, which may be electrically connected with the components of the transmitter 101. The power processor 114 may receive AC power from the power source 102 to generate DC power.

The transmitted ultrasound waves 107 may undergo constructive interference and generate a narrow main lobe and low-level side lobes to help focus and/or direct the ultrasonic energy. The ultrasonic energy generated by the sending transducer 106 of the transmitter 101 may also be focused using techniques such as geometric focusing, time reversal methods, beam forming via phase lags, or through the use of an electronically controlled array.

The transmitter 101 may scan an area for receivers, such as the receiver 108, may sense location of a receiver within a room, may track a receiver, and may steer an ultrasonic beam toward the receiver. The transmitter 101 may optionally not emit ultrasonic energy unless a receiver, such as the receiver 108 is determined to be within a given range.

The sending transducer 106 of the transmitter 101 may be mechanically and/or electronically oriented towards a receiver, such as the receiver 108. For example, in some embodiments, the sending transducer 106 may be tilted in the XY-direction using a motor, and beams generated by the sending transducer 106 may be steered electronically in the Z-direction. The sending transducer 106 of the transmitter 101 may transmit ultrasonic energy to the receiver 108 via line-of-sight transmission or by spreading the ultrasound pulse equally in all directions. For line-of-sight transmission, the sending transducer 106 and the receiving transducer 109 may be physically oriented toward each other. The sending transducer 106 of the transmitter 101 may physically or electronically (or both) be aimed at the receiving transducer 109 of the receiver 108 or the receiving transducer 109 may be so aimed at the sending transducer 106. The transmitter 101 may transmit signals, such as an ultrasonic, radio, or other such signal, to be sensed by the receiver 108 for the purpose of detecting orientation, location, communication, or other purposes, or vice versa. One or both of the transmitter 101 and the receiver 108 may include a signal receiver such as antennas 112 and 113, respectively, that may receive signals from the receiver 108 or the transmitter 101, respectively. Likewise, signals may be transmitted from the transmitter 101 to the receiver 108 using the ultrasonic waves themselves.

The transmitter 101 may be thermo-regulated by managing the duty cycles of the components of the transmitter 101. Thermoregulation may also be achieved by attaching heat sinks to the sending transducer 106, using fans, and/or running a coolant through the transmitter, and other thermoregulation methods.

The receiver 108 may include the receiving transducer 109, which may convert ultrasonic energy in the form of ultrasonic waves to electrical energy. The receiving transducer 109 may include one or more transducers arranged in an array that can receive unfocused or a focused beam of ultrasonic energy. The receiving transducer 109 may include at least one Capacitive Micromachined Ultrasonic Transducer (CMUT), a Capacitive Ultrasonic Transducer (CUT), or an electrostatic transducer, or a piezoelectric-type transducer described below, a combination thereof or any other type or types of transducer that can convert ultrasound into electrical energy. For receiving focused ultrasonic energy via a phased array, the receiving transducer 109 may include a timed delay transducer or a parametric transducer. The receiving transducer 109 may operate for example between about 20 to about 120 kHz for receipt of ultrasonic energy through air, and up to about 155 dB, for example. For receiving ultrasonic energy through other medium, the receiving transducer 109 may operate at frequencies greater than or equal to 1 MHz, for example. The receiving transducer 109 may have a high electromechanical conversion efficiency, for example of about 40%, corresponding to about a 3 dB loss.

The receiving transducer 109 may supply electrical energy to an energy storage device 110 and/or a processor 115. Examples of an energy storage device 110 can include, but are not limited to, a battery, a capacitive storage device, an electrostatic storage device, etc. Examples of a processor can include, but not limited to, a processor or chipset for a smartphone, a portable computer, an electronic content reader, a TV, or any other suitable electronic device.

In accordance with various embodiments, the receiver 108 may include a receiving transducer 109 that may include piezoelectrically actuated flexural mode transducers, flextensional transducers, a flexural mode piezoelectric transducers, and/or a Bimorph-type piezoelectric transducers (“PZT”). These may be attached to a metal membrane and the structure may resonate in a flexing mode rather than in a brick mode. In embodiments, the structure may be clamped around the rim by an attachment to the transducer housing. The PZT slab may be electrically matched to the rectifier electronics. This can be a high Q resonator (it can resonate at a single frequency) that can be held by very low impedance material.

The receiver 108 may further include the receiver controller 111 in communication with the receiving transducer 109 and the magnetic resonance receiver 117. The receiver controller 111 may cause the receiving transducer 109 to receive ultrasonic waves based on the proximity of the receiving transducer 109 to a sending transducer 106. Receiving transducer 109 can convert ultrasonic energy received from a sending transducer 106 to electrical energy. Proximity can be the actual or effective distance between the receiving transducer 109 and the sending transducer 106. Effective distance can be based on the efficiency of energy transmission between receiving the transducer 109 and the sending transducer 106 based on various factors that can include, without limitation, their relative locations; the characteristics of the conductive medium (e.g., the air, tissue, etc.) between transmitter and receiver; the relative orientation of the transmitter and receiver; obstructions that may exist between the transmitter and receiver; relative movement between transmitter and receiver; etc. In some cases, a first transmitter/receiver pair may have a higher proximity than a second transmitter/receiver pair, even though the first pair is separated by a greater distance than the second pair.

The receiver controller 111 may cause a beam of ultrasonic energy to be received from the sending transducer 106. Further, the receiver controller 111 may cause the sending transducer 106 to receive ultrasonic waves having at least one frequency and at least one amplitude.

The receiver 108 may further include a communication device (not shown) that may send an interrogation signal through antenna 113 to detect the transmitter 101 and help to determine characteristics of the transmitter 101, including the sending transducer 106. The receiver communication device can send a control signal to a sender communication device, which can be in communication with the sender transmitter controller 105. The sender transmitter controller 105 can control the sending transducer 106. The control signal may include the frequency and/or amplitude of the ultrasonic waves received by the receiving transducer 109. The control signal may be used to determine the proximity and/or relative orientation of the receiving transducer 109 to the sending transducer 106. Additionally, the control signal may include, without limitation, an instruction to be executed by the sender transmitter controller 105; the impedance of the receiving transducer 109; a desired power level; a desired frequency, etc.

The receiver communications device may receive a control signal from a sender communications device that can be in communication with the sender transmitter controller 105. The control signal may include the frequency and/or amplitude of ultrasonic energy emitted by sending transducer 106. Additionally, the control signal may include an instruction to be executed by the receiver controller 111 and may also include an interrogation signal to detect a power status from receiving transducer 109. The control signal may be used to determine the proximity and/or relative orientation of receiving transducer 109 to sending transducer 106.

A communications device may send a signal by modulating the ultrasonic waves generated by the transducer for in-band communications. The communication device can also be used to modulate an out-of-band signal, such as a radio signal, for communication to another communication device. The radio signal can be generated by a separate radio transmitter that may use an antenna.

The system may include communication between receiver and transmitter to, for example, adjust frequency to optimize performance in terms of electro acoustical conversion, modulate ultrasonic power output to match power demand at a device coupled to the receiver, etc. For example, if it is determined that the ultrasound waves received by the receiver 108 are too weak, a signal can be sent through the communications devices to the transmitter 101 to increase the output power of the sending transducer 106. The sender transmitter controller 105 may then cause sending transducer 106 to increase the power of the ultrasonic waves being generated. In the same way, the frequency, duration, and directional characteristics (such as the degree of focus) of the ultrasonic waves may be adjusted accordingly.

The transmitter 101 and the receiver 108 may communicate to coordinate the transmission and receipt of ultrasonic energy. Communications between the transmitter 101 and the receiver 108 may occur in-band (e.g., using the ultrasonic waves that are used to convey power from the transmitter to the receiver to also carry communications signals) and/or out-of-band (e.g., using separate ultrasonic waves from those used to carry power or, for example, radio waves based on a transmitter or transceiver at the transmitter and receiver.) In an embodiment, a range detection system (not shown) may be included at the transmitter 101, at the receiver 108 or both. The range detection system at the transmitter can use echolocation based on the ultrasound waves sent to the receiver, the Bluetooth wireless communications protocol or any other wireless communications technology suitable for determining the range between a device and one or more other devices. For example, the strength of a Bluetooth or Wi-Fi signal can be used to estimate actual or effective range between devices. For example, the weaker the signal, the more actual or effective distance can be determined to exist between the two devices. Likewise, the failure of a device to establish a communications link with another device (e.g., using a Bluetooth or Wi-Fi (e.g., 802.11) signal with another device can establish that the other device is beyond a certain distance or range of distances from a first device. Also, a fraction of the waves can reflect back to the transmitter from the receiver. The delay between transmission and receipt of the echo can help the transmitter to determine the distance to the receiver. The receiver can likewise have a similar echolocation system that uses sound waves to assess the distance between the receiver and the transmitter.

Impedance of the sending transducer 106 and receiving transducer 109 may be the same and/or may be synchronized. In this regard, for example, both the sending transducer 106 and receiving transducer 109 may operate at the same frequency range and intensity range, and have the same sensitivity factor and beam width.

Communications between transmitter 101 and receiver 108 may also be used to exchange impedance information to help match the impedance of the system. Impedance information can include any information that is relevant to determining and/or matching the impedance of the transmitter and/or receiver, which can be useful in optimizing the efficiency of energy transfer. For example, the receiver 108 can send impedance information via a communication signal (e.g., a “control signal”) that includes a frequency or a range of frequencies that the receiver 108 is adapted to receive. The frequency or range of frequencies may be the optimal frequencies for reception. Impedance information can also include amplitude data from the receiver 108, e.g., the optimal amplitude or amplitudes at which the receiver 108 can receive ultrasound waves. In an embodiment, an amplitude is associated with a frequency to identify to the transmitter 101 the optimal amplitude for receiving ultrasound at the receiver 108 at the specified frequency. In an embodiment, impedance information may include a set of frequencies and associated amplitudes at which the receiving transducer 109 of the receiver 108 optimally can receive the ultrasound waves and/or at which the sending transducer 106 of the transmitter 101 can optimally transmit the ultrasound. Impedance information can also include information about the sensitivity of sending transducer 106 and the receiving transducer 109, beam width, intensity, etc. The sensitivity may be tuned in some embodiments by changing the bias voltage, at least for embodiments using CMUT technology.

Communications can also include signals for determining location information for the transmitter 101 and/or the receiver 108. For example, location information for receivers such as the receiver 108 can be associated with receiver identifiers (e.g., Electronic Identification Numbers, phone numbers, Internet Protocol, Ethernet or other network addresses, device identifiers, etc.) This can be used to establish a profile of the devices at or near a given location at one time or over one or more time ranges. This information can be provided to third parties. For example, embodiments of the system may determine a set of device identifiers that are proximate to a given location and to each other. The fact that they are proximate; the location at which they are proximate; information about each device (e.g., a device's position relative to one or other device, a device's absolute location, power information about a device, etc.) can be shared with a third party, such as an third party application that would find such information useful. Further, similar such information can be imported into embodiments of the present invention from third party sources and applications.

Embodiments of communications protocols between the transmitter 101 and the receivers such as the receiver 108 can be used to dynamically tune the beam characteristics and/or device characteristics to enable and/or to optimize the transmission of power from the transmitter 101 to the receiver 108. For example, at a given distance, it may be optimal to operate at a given frequency and intensity. The transmitter 101 may serve several different receivers by, for example, steering and tuning the beam for each receiver, such as the receiver 108, e.g., in a round-robin or random fashion. Thus, the beam for a device A may be at 40 kHz and 145 dB, device B may be at 60 kHz and 130 dB and device C at 75 kHz and 150 dB. The transmitter can tune itself to transmit an optimally shaped beam to each of these dynamically, changing beam characteristics as the transmitter shifts from one device to another. Further, dwell time on each receiver 108 may be modulated to achieve particular power transfer objectives.

The transmitter 101 may receive a signal (one or more control signals) from the receiver 108 indicating one or more of the receiver's distance, orientation, optimal frequencies, amplitudes, sensitivity, beam width, etc. For example, optimal frequency when a receiver is less than 1 foot away from a transmitter may be 110 kHz with a 1.7 dB/ft attenuation rate, and optimal frequency when a receiver is farther than 1 foot away from a transmitter may be 50 kHz with a 0.4 dB/foot attenuation rate. The receiver 108 may detect the distance and provide a signal to the transmitter 101 to change its frequency accordingly. In response, the transmitter 101 can tune the sending transducer 106 to transmit the best beam possible to transfer the most power in the most reliable fashion to the receiver. These parameters can be dynamically adjusted during the transmission of ultrasonic energy from the transmitter 101 to the receiver 108, e.g., to account for changes in the relative positions of the transmitter 101 and the receiver 108, changes in the transmission medium, etc.

Likewise, the receiver 108 may configure itself in response to signals received from the transmitter 101. For example, the receiver 108 may tune the receiving transducer 109 to a given frequency and adjust its sensitivity to most efficiently receive and convert ultrasound waves from the sending transducer 106 of the transmitter 101 to electrical energy.

Dwell time of the transmitter 101 on the receiver 108 may also be adjusted to optimize the energy delivered by the transmitter to several receivers around the same time. For example, the transmitter 101 may receive power requirements information from each of five receivers. It may cause the sending transducer 106 to dwell on the neediest receiver for a longer time interval than a less needy receiver as it services (e.g., sends ultrasound waves to) each receiver, e.g., in round-robin fashion.

The sending transducer 106 may be configured as an array of ultrasonic transducers and/or apertures of ultrasonic transducers. The ultrasonic transducers may be used to produce a beam of ultrasonic energy. The sending transducer 106 may be controlled by the sender transmitter controller 105 to produce any number of ultrasonic beams and may produce each such beam or combination of beams with a given shape, direction, focal length and any other focal property of the beam. The sending transducer 106 may include one or more steering components, including one or more electronic steering components, e.g., one or more configurations or patterns or array elements and/or apertures. Apertures of the sending transducer 106 may be convex to help control beam properties such as focal length. The sending transducer 106 may have a mechanical steering component that works alone or in combination with one or more electronic steering components to control focal properties of one or more ultrasonic beams.

The transmitter 101 may have a first value of a configuration parameter. A configuration parameter can be used to describe an actual or potential state or condition of the sending transducer 106 or the receiving transducer 109, and may include, for example, an amplitude, a frequency, a steering parameter, an instruction, a power status, a transmitter characteristic and a receiver characteristic. A sender characteristic can describe an actual or potential condition of the sending transducer 106 or the receiving transducer 109. For example, a sender characteristic may relate to the power state of the sending transducer 106 and have the values ON (emitting ultrasound to be converted into electrical energy by a receiver) or OFF. Another power configuration parameter may relate to the power level of the emitted ultrasonic energy in various units, such as watts per square inch, decibels, etc.

A characteristic may describe an actual or potential condition of the sending transducer 106 or the receiving transducer 109, or the transmitter 101 or the receiver 108, that may be fixed. For example, a characteristic can be a telephone number, Electronic Serial Number (ESN), Mobile Equipment Identifier (MEID), IP address, MAC address, etc., or a mobile or stationary device that can be a transmitter such as the transmitter 101 or a receiver such as the receiver 108. A characteristic can be a fixed impedance or other electronic property (e.g., transducer type, software/firmware version, etc.) of a device.

Based on input received through the sender communications device, the transmitter 101 can change its configuration parameter value to a second configuration parameter value and thereby change its state and/or behavior. Mechanisms for changing the configuration parameter of the transmitter 101 can include receiving a new configuration parameter value through the communications device. The new configuration parameter value can originate from a receiver, such as the receiver 108, to which the transmitter 101 is transmitting or intends to transmit ultrasonic energy. For example, the sending transducer 106 of the transmitter 101 may be transmitting ultrasonic energy at a first power level and the receiver 108 may send a message to the transmitter 101 requesting that the energy be transmitted at a second power level. For example, the receiver 108 may send a request asking that the power of transmitted ultrasound be boosted from 120 dB to 140 dB. The transmitter 101 can then change the power level configuration parameter for the sending transducer 106 from 120 dB to 140 dB.

The first configuration parameter may be changed based on input received through the communications device, even when that input does not specify a new (second) value for the configuration parameter. For example, input can be received at the sender communications device from the receiver 108 that includes a request to increase the power of the transmitted ultrasonic energy. In response, the transmitter 101 can change the value of the power configuration parameter for the sending transducer 106 from the first value to a second value, e.g., from 120 dB to 140 dB. Likewise, one or more configuration parameters can be changed based on a combinations of inputs from one or more receivers or third parties. For example, a beam shape can be changed based upon a receiver characteristic, such as the type of ultrasonic transducer used by the receiving transducer 109.

A configuration parameter can be or include one or more steering parameters.

Examples of steering parameters include a steering angle, such as the angle at which a mechanical tilt device has disposed or can disposed one or more ultrasonic transducer elements of the sending transducer 106; a dispersion angle, such as the angle at which a threshold power occurs in an ultrasonic beam (e.g., the beam width expressed as an angle); a focal length, such as a distance in centimeters at which an ultrasonic beam becomes most focused; a transmitter location, such as the angle and distance of a receiver 108 from a transmitter 101, or the distance of a transmitter 101 from a receiver 108, or the absolute position (e.g., from a given reference point) of a transmitter 101 or a receiver 108; and a relative orientation of a transmitter 101 and a receiver 108, such as the difference in the relative orientation of a sending transducer 106 and a receiver transducer 109, expressed in the degrees from parallel. For example, when one transducer is parallel to another, they can be said to have a zero degree offset. When one is perpendicular in orientation to another, they can have a ninety degree offset, etc.

A first steering parameter may be changed in order to adjust and/or improve the efficiency of the transmission of ultrasonic energy to a receiver such as the receiver 108. The steering parameter may be changed based on input received through the communications device, even when that input does not specify a new (second) value for the steering parameter. For example, input can be received at the sender communications device from a receiver, such as the receiver 108, that includes an amount of the transmitted ultrasonic energy being received, e.g., 120 dB. In response, the transmitter 101 can change the value of the steering parameter, e.g., relative orientation, from the first value to a second value, e.g., from a ninety degree offset to a zero degree offset. As a result of changing/adjusting the steering parameter, the efficiency of the transmission of ultrasonic energy to the receiver 108 may improve, and the amount of the transmitted ultrasonic energy being received may increase, e.g., from 120 dB to 140 dB. For example, the amount of power at the receiver 108 can be monitored by the receiver 108 and used as a basis for generating an input to be sent to the transmitter 101 to adjust one or more of its configuration parameters. This can change the way in which ultrasonic energy is transmitted by the sending transducer 106 of the transmitter 101 to the receiving transducer 109 of the receiver 108, e.g., by changing the tilt of a mechanical steering mechanism for the sending transducer 106, by changing the power level of the transmitted ultrasonic energy, by changing the electronic steering and beam shaping of the ultrasonic energy at the sending transducer 106, etc. In this way, the receiver 108 can provide real-time or near-real-time feedback to the transmitter 101 so that the transmitter 101 can tune the way in which it sends ultrasonic energy to the receiver 108 to improve the rate at which energy is transferred (e.g., power), the continuity of energy transfer, the duration of energy transfer, etc.

Beam steering and focusing can be achieved by causing the transmitter controller 105 to modulate (control) the phase of the electrical signal sent to the sending transducer 106 or to various elements of the sending transducer 106. For wide-angle steering, elements of size λ/2 can be used, e.g., having a size of around 4 mm. Some semiconductor companies (Supertex, Maxim, Clare, etc.) manufacture high voltage switch chips that can allow a few high-power oscillator circuits to take the place of thousands of transmitters. The transmitter controller 105 may modulate the phase of the signal in any suitable manner, for example, using any suitable control electronics.

The transmitter 101 may use data about receivers, such as the receiver 108, including, for example, data about power received by various receivers and data about the location of various receivers, to coordinate the wireless power being transferred to the receivers by the sending transducer 106 and the magnetic resonance transmitter 116. For example, location data from the receivers may indicate that no receiver, including the receiver 108, may be close enough to the magnetic resonance transmitter 116 to receive power from the oscillating magnetic field 118. The transmitter 101 may remove, or reduce, the power supplied to the magnetic resonance transmitter 116. This may result in no, or a smaller, oscillating magnetic field 118, conserving power. The transmitter controller 105 may control the sending transducer 106 to supply power to the various receivers though ultrasound waves 107.

A receiver, for example, the receiver 108, may move within a specified distance of the magnetic resonance transmitter 116. The receiver 108 may be determined to be close enough to the magnetic resonance transmitter 116 in any suitable manner. For example, the transmitter 101 may use location data received from receivers, cameras for visible and infrared light, radar, Lidar, ultrasonic object tracking, or any other suitable form of object tracking, to determine the location and orientation of receivers. The transmitter 101 may also determine which receivers are proximate to the magnetic resonance transmitter 116 by, for example, temporarily activating the oscillating magnetic field 118, and receiving reports from receivers which detected the temporary activation through current induced in the wire coils of their magnetic resonance receivers. The transmitter 101 may also determine which receivers are proximate to the magnetic resonance transmitter 116, for example, based on near-field communications device that may be part of the transmitter 101 and the receivers. The near-field communications device of receiver may only be able to communicate with the near-field communications devices of the transmitter 101 when the receiver is close enough to the transmitter 101 for the magnetic resonance receiver of the receiver to receive power from the oscillating magnetic field 118 generated by the magnetic resonance transmitter 116.

When a receiver, for example, the receiver 108, is determined to be within the specified distance, for example, is close enough to the magnetic resonance transmitter 116 to receive power from the oscillating magnetic field 118, the transmitter controller 105 may cause power to be supplied to the magnetic resonance transmitter 116. The magnetic resonance transmitter 116 may generate the oscillating magnetic field 118, which may induce current in wire coils of the magnetic resonance receiver 117 generating electrical energy that may be used by the receiver 108. The receiver 108 may communicate power data to the transmitter 101, for example, indicating the amount of power the receiver 108 is receiving from the magnetic resonance transmitter 116, or from both the magnetic resonance transmitter 116 and the sending transducer 106, as well as a power requirement indicating the amount of power the receiver 108 would like to receive. The transmitter controller 105 may control the sending transducer 106 based on the power data from the receiver 108, for example, reducing the amount of power delivered to the receiving transducer 109 through the ultrasonic waves 107 if the receiver 108 is receiving sufficient power from the magnetic resonance transmitter 116. This may allow power from the sending transducer 106 to be redirected to other receivers while the receiver 108 is receiving power from the magnetic resonance transmitter 116.

If the receiver 108, receiving power from the magnetic resonance transmitter 116, is positioned such that the receiving transducer 109 cannot receive the ultrasonic waves 107, for example, is positioned at an oblique angle or with no line-of-sight to the ultrasonic transducers of the sending transducer 106, the transmitter controller 105 may cause the sending transducer 106 to cease supplying any power to the receiver 108. The controller may, for example, turn off particular ultrasonic transducers or redirect ultrasonic beams from the ultrasonic transducers towards other receivers. The transmitter controller 105 may, if possible, increase the power provided to the magnetic resonance transmitter 116, so that the power the receiver 108 no longer receives from the sending transducer 106 though ultrasonic waves 107 received at the receiving transducer 109 may be replaced with power from the magnetic resonance transmitter 116 through the oscillating magnetic field 118 inducing current at the magnetic resonance receiver 117.

The receiver 108, while receiving power from the magnetic resonance transmitter 116, may begin to move away from the transmitter 101. Power data sent to the transmitter 101 by the receiver 108 may indicate a decrease in total power, or a decrease in power from the magnetic resonance transmitter 116, received by the by the receiver 108. The transmitter controller 105 may cause the sending transducer 106 to increase the amount of power delivered to the receiving transducer 109, for example, increasing the number of ultrasonic transducers used to generate an ultrasonic beam directed at the receiver 108, or increasing the amplitude of the generated ultrasonic waves 107 directed at the receiver 108. This may compensate for the decrease in power to the receiver 108 from the magnetic resonance transmitter 116. When the receiver 108 has moved a sufficient distance from the transmitter 101, the receiver 108 may no longer receiver power from the magnetic resonance transmitter 116. The transmitter 101 may determine that the receiver 108 is no longer receiving power from the magnetic resonance transmitter 116 in any suitable manner. For example, the receiver 108 may communicate to the transmitter 101 that it is no longer receiving power from the magnetic resonance transmitter 116, the transmitter 101 may determine based on any suitable location data or object tracking data that the receiver 108 has moved outside of the specified distance from the magnetic resonance transmitter 116 within which the receiver 108 can receiver power from the magnetic resonance transmitter 116, or communication between near-field communication devices of the receiver 108 and transmitter 101 may be cut-off due to distance. The transmitter controller 105 may cause the sending transducer 106 to increase the amount of power transmitted to the receiver 108, and may also decrease or remove power being supplied to the magnetic resonance transmitter 116, for example, if there are no other receivers close enough to receive power from the magnetic resonance transmitter 116.

FIG. 1B shows an exemplary system in accordance with the disclosed subject matter. The transmitter 101 may also include an infrared laser transmitter 119. The infrared laser transmitter 119 may be any infrared laser power transmitter, including any suitable number of infrared lasers arranged in any suitable manner. The infrared laser transmitter 119 may receive electrical energy from any suitable source. For example, the infrared laser transmitter 119 may receive an amplified signal from the amplifier 104, or from other suitable components of the transmitter 101. The amplified signal received at the infrared laser transmitter 119 may be based on a signal from the signal generator 103 separate from the signal used by the sending transducer 106, or may be based on a signal from a signal generator incorporated into the infrared laser transmitter 119. The magnetic resonance transmitter 116 may also receive power directly, for example, from a power processor 114 of the transmitter 101, and may generate and amplify signals using its own electrical and electronic components separate from the signal generator 103 and the amplifier 104. The infrared laser transmitter 119 may generate generated infrared light, which may be able to cause the generation of electrical current by photo-voltaic materials.

The receiver 108 may include a photo-voltaic receiver 120. The photo-voltaic receiver 120 may be a photo-voltaic array, which may include any suitable number of photo-voltaic devices, made of any suitable photo-voltaic materials, arranged in any suitable manner. The photo-voltaic receiver 12 may be located in any suitable location on the receiver 108, such as, for example, on a surface of the receiver 108 in proximity to the ultrasonic transducers of the receiving transducer 109, or in an area away from the ultrasonic transducers, for example on an edge of the receiver 108. When there is clear line-of-sight between the infrared lasers of the infrared laser transmitter 119 and the photo-voltaic receiver 120, with no people or animals in proximity to the line-of-sight or on the line-of-sight as extended through the receiver 108, the infrared laser transmitter 119 may generated a beam of infrared light 121 that may be directed at the photo-voltaic receiver 120 and may result in the generation of current by the photo-voltaic receiver 120. The current generated by the photo-voltaic receiver 120 may be used as electrical energy by the receiver 108, for example, to charge energy storage device 110 or power processor 111.

The transmitter controller 105 may control and coordinate the infrared laser transmitter 119 and the sending transducer 106. For example, the transmitter controller 105 may be a master controller which may control subordinate controllers of infrared laser transmitter 119 and the sending transducer 106, or the transmitter controller 105 may control both the infrared laser transmitter 119 and the sending transducer 106 directly. The transmitter controller 105 may, for example, activate and deactivate the infrared laser transmitter 119 based on the availability of clear lines-of-sight between the infrared laser transmitter 119 and photo-voltaic receivers, such as the photo-voltaic receiver 120. The transmitter controller 105 may activate, deactivate, and steer ultrasonic beams generated by the ultrasonic transducers 106 based on the location and orientations of receivers such as the receiver 108 relative to the transmitter 101, and on power data from receivers.

The transmitter 101 may use data about receivers, such as the receiver 108, including, for example, data about power received by various receivers and data about the location of various receivers, as well as data about the location of people and animals relative to the recievers, to coordinate the wireless power being transferred to the receivers by the sending transducer 106 and the infrared laser transmitter 119. For example, location data from the receivers and location data about people and animals gathered using, for example, cameras, radar, Lidar, ultrasonic object tracking, or other suitable object tracking, may indicate that there is no clear line-of-sight without any proximate person or animal between the infrared laser transmitter 119 and any receiver, including the receiver 108. The transmitter 101 may remove or reduce the power supplied to the infrared laser transmitter 119, which may turn off any infrared lasers so that no infrared light is generated. The transmitter controller 105 may control the sending transducer 106 to supply power to the various receivers though ultrasound waves 107, as the sending transducer 106 may need a less clear line-of-sight than the infrared laser transmitter 119. For example, if a person is holding the receiver 108, their presence may preclude the usage of the infrared laser transmitter 119 due to their proximity to an otherwise clear line-of-sight, but the otherwise clear line-of-sight may be usable by the sending transducer 106.

A receiver, for example, the receiver 108, may have its line-of-sight from its photo-voltaic receiver to the infrared laser transmitter 119 clear without any proximate people or animals. The line-of-sight between the photo-voltaic receiver 120 of the receiver 108 and the infrared laser transmitter 119 of the transmitter 101 may be determined to be clear and without any proximate people or animals in any suitable manner. For example, the transmitter 101 may use location data received from receivers, cameras for visible and infrared light, radar, Lidar, ultrasonic object tracking, or any other suitable form of object tracking, to determine the location and orientation of receivers and the location of people and animals relative to the receivers.

When the line-of-sight between the photo-voltaic receiver of a receiver, for example, the photo voltaic receiver 120 of the receiver 108, and the infrared laser transmitter 119 of the transmitter 101 is determined to be clear without any proximate people or animals, the transmitter controller 105 may cause power to be supplied to the infrared laser transmitter 119 to drive the infrared lasers. The infrared laser transmitter 119 may generate a beam of infrared light 121, which may be targeted at the photo-voltaic array 120 of the receiver 108, and may cause the photo-voltaic array 120 to generate current, generating electrical energy that may be used by the receiver 108. The receiver 108 may communicate power data to the transmitter 101, for example, indicating the amount of power the receiver 108 is receiving from the infrared laser transmitter 119, or from both the infrared laser transmitter 119 and the sending transducer 106, as well as the amount of power the receiver 108 would like to receive. The transmitter controller 105 may control the sending transducer 106 based on the power data from the receiver 108, for example, reducing the amount of power delivered to the receiving transducer 109 through the ultrasonic waves 107 if the receiver 108 is receiving sufficient power from the infrared laser transmitter 119. This may allow power from the sending transducer 106 to be redirected to other receivers while the receiver 108 is receiving power from the infrared laser transmitter 119.

If the receiver 108, receiving power from the infrared laser transmitter 119, is positioned such that the receiving transducer 109 cannot receive the ultrasonic waves 107, for example, is positioned at an oblique angle or with no line-of-sight to the ultrasonic transducers of the sending transducer 106, the transmitter controller 105 may cause the sending transducer 106 to cease supplying any power to the receiver 108. The controller may, for example, turn off particular ultrasonic transducers or redirect ultrasonic beams from the ultrasonic transducers towards other receivers. The transmitter controller 105 may increase the power provided to the infrared laser transmitter 119, so that the power the receiver 108 no longer receives from the sending transducer 106 though ultrasonic waves 107 received at the receiving transducer 109 may be replaced with power from the infrared laser transmitter 119 through the beam of infrared light 121 causing current generation at the photo-voltaic receiver 120.

The receiver 108, while receiving power from the infrared laser transmitter 119, may have its line-of-sight to the infrared laser transmitter 119 blocked, or a person or animal may move proximate to the line-of-sight. For example, a person may move near the line-of-sight, or an object may obstruct the line-of-sight. The transmitter 101 may determine the line-of-sight is no longer clear, as a person or animal is near the line-of-sight or the line-of-sight is blocked, based on any suitable data, including, for example, power data from the receiver 108 and location data for people and animals. For example, if the line-of-sight is blocked due to a physical obstruction that is not a person or animal, power data sent to the transmitter 101 from the receiver 108 may indicate that the amount of power generated by the photo-voltaic receiver 120 had dropped suddenly. A person or animal may be detected as being proximate to the line-of-sight by, for example, a camera, radar, lidar, ultrasonic object tracking, or any other suitable object tracking of the transmitter 101 that may detect and identify the location of people and animals. The transmitter controller 105 may decrease or remove power being supplied to the infrared laser transmitter 119, causing the infrared lasers to be shut off if, for example, there are no other receivers with a clear line-of-sight to which the beam of infrared light 121 can be directed. The transmitter controller 105 may also cause the sending transducer 106 to increase the amount of power delivered to the receiving transducer 109, for example, increasing the number of ultrasonic transducers used to generate an ultrasonic beam directed at the receiver 108, or increasing the amplitude of the generated ultrasonic waves 107 directed at the receiver 108. This may compensate for the loss of power to the receiver 108 from the infrared laser transmitter 119.

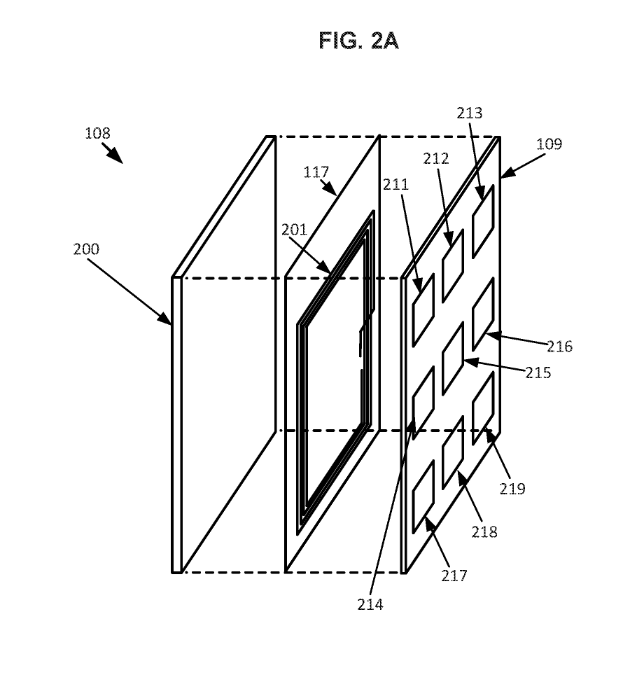

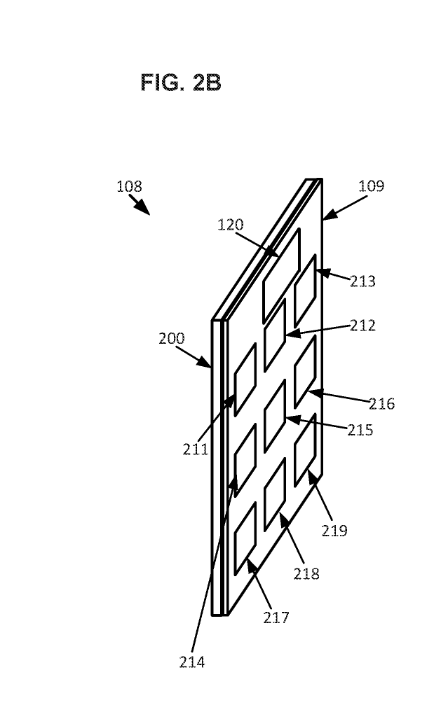

FIG. 2A shows an exemplary device in accordance with the disclosed subject matter. The receiver 108 may be any suitable electronic device, such as, for example, a smartphone, tablet, laptop, or TV or other display. The receiver 108 may include multiple wireless power transfer devices. For example, the receiving transducer 109, including ultrasonic transducers 211, 212, 213, 214, 215, 216, 217, 218, and 219, may be arranged on the back surface of the receiver 108. The magnetic resonance receiver 117, including wire coil 201, may be arranged behind the back surface of the receiver 108, behind the receiving transducer 109. The device 200, which may include any other components of the receiver 108 that are not part of the receiving transducer 109 or the magnetic resonance receiver 117, may be arranged such that the magnetic resonance receiver 117 is in between the device 200 and the receiving transducer 109, which may serve as the back of the receiver 108. The device 200 may include, for example, a display, hardware interface devices, the processor 115, the receiver controller 111, and the energy storage device 110. The device 200 may also include components that may work with, or be part of, the sending transducer 109 and the magnetic resonance receiver 117. The device 200, sending transducer 109, and magnetic resonance receiver 117 may be connected in any suitable manner in order for electrical energy to be provided from the magnetic resonance receiver 117 and the sending transducer 109 to the device 200, and for data to be communicated between the device 200 magnetic resonance receiver 117 and the sending transducer 109. The device 200, magnetic resonance receiver 117 and the sending transducer 109 may be attached in any suitable manner. In some implementations, the magnetic resonance receiver 117 and/or the sending transducer 109 may be physically separate from the device 200. For example, the device 200 may be a smartphone, and the magnetic resonance receiver 117 and the sending transducer 109 may be implemented as a case which may be attachable and detachable from the smartphone, or as an accessory which may be connected to the smartphone through a wired connection, such as a dock, as a part of an external battery pack, or as an external charging device. In some implementations, ultrasonic transducers of the receiving transducer 109 may be arranged on other surfaces of the receiver 108, including, for example, sides and edges of the device 200, in addition to or in place of being arrange on the back surface of the receiver 108.

FIG. 2B shows an exemplary device in accordance with the disclosed subject matter. The receiver 108 may include multiple wireless power transfer devices. For example, the receiving transducer 109, including the ultrasonic transducers 211, 212, 213, 214, 215, 216, 217, 218, and 219, may be arranged on the back surface of the receiver 108. The photo-voltaic receiver 120, may also be arranged on the back surface of the receiver 108. The photo-voltaic receiver 120 may also be positioned on other surfaces of the receiver 108, including, for example, on sides or edges of the device 200. The photo-voltaic devices of the photo-voltaic receiver 120 may also be split across multiple areas and surfaces of the receiver 108. The device 200, sending transducer 109, and photo-voltaic receiver 120 may be connected in any suitable manner in order for electrical energy to be provided from the photo-voltaic receiver 120 and the sending transducer 109 to the device 200, and for data to be communicated between the device 200, phot-voltaic receiver 120, and the sending transducer 109. The device 200, photo-voltaic receiver 120, and the sending transducer 109 may be attached in any suitable manner. In some implementations, the photo-voltaic receiver 120 and/or the sending transducer 109 may be physically separate from the device 200. For example, the device 200 may be a smartphone, and the photo-voltaic receiver 120 and the sending transducer 109 may be implemented as a case which may be attachable and detachable from the smartphone, or as an accessory which may be connected to the smartphone through a wired connection, such as a dock, as a part of an external battery pack, or as an external charging device. In some implementations, ultrasonic transducers of the receiving transducer 109 may be arranged on other surfaces of the receiver 108, including, for example, sides and edges of the device 200, in addition to or in place of being arrange on the back surface of the receiver 108.

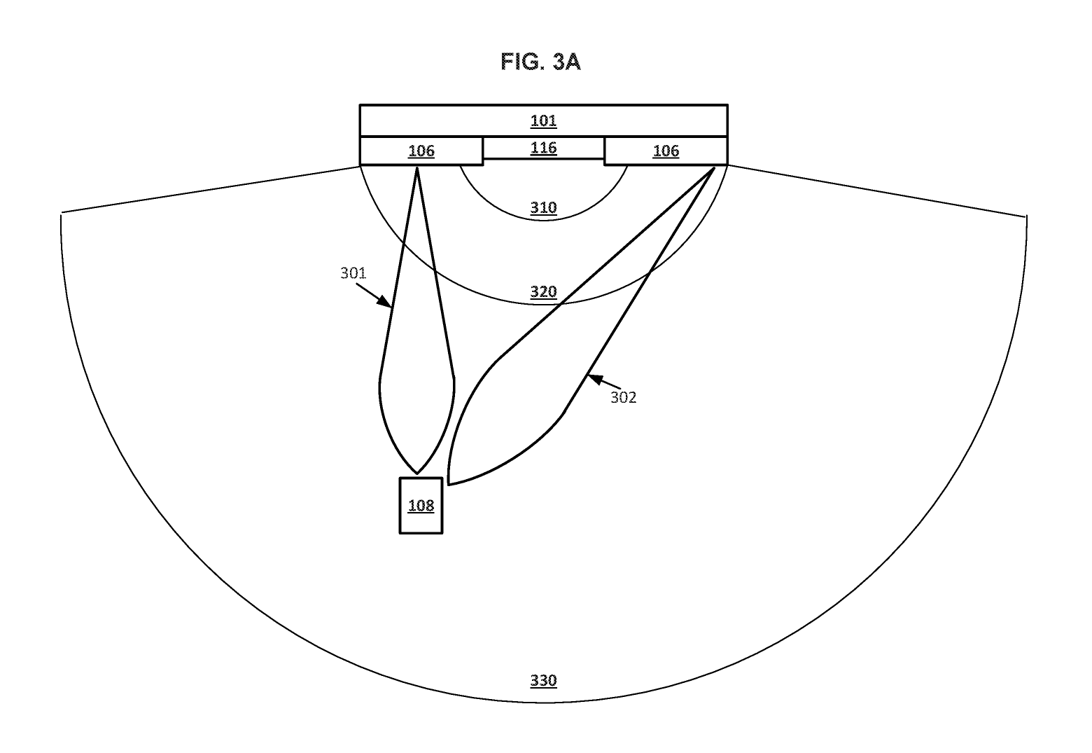

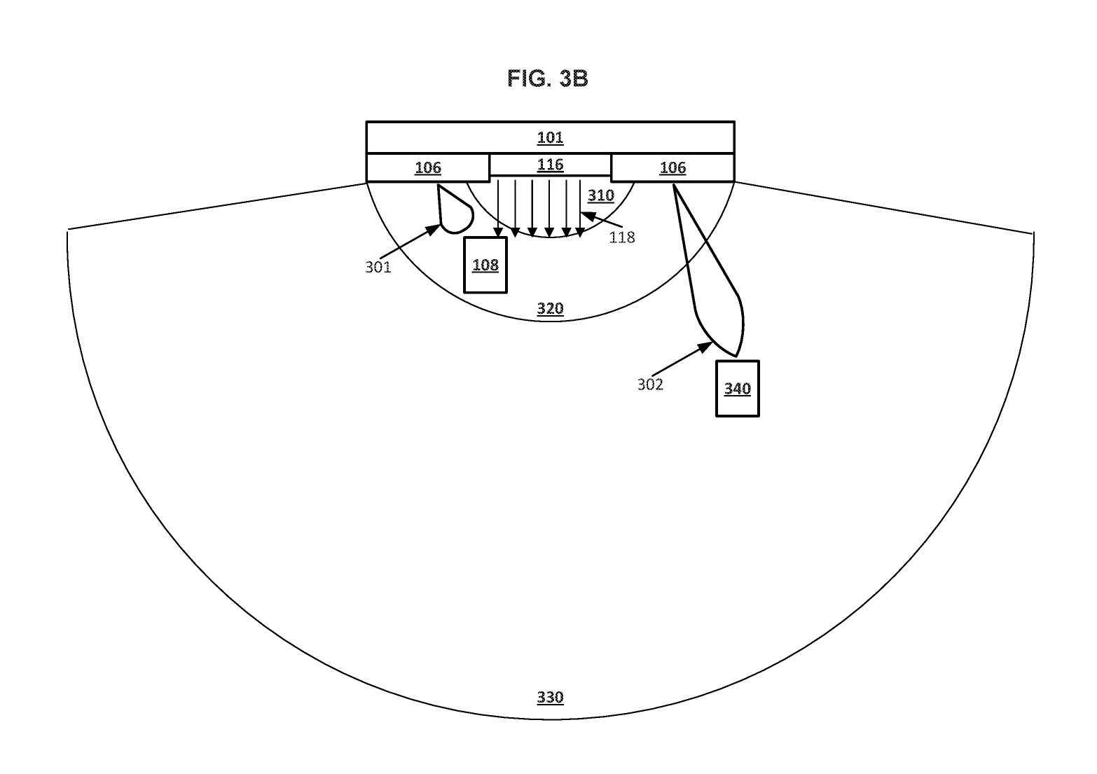

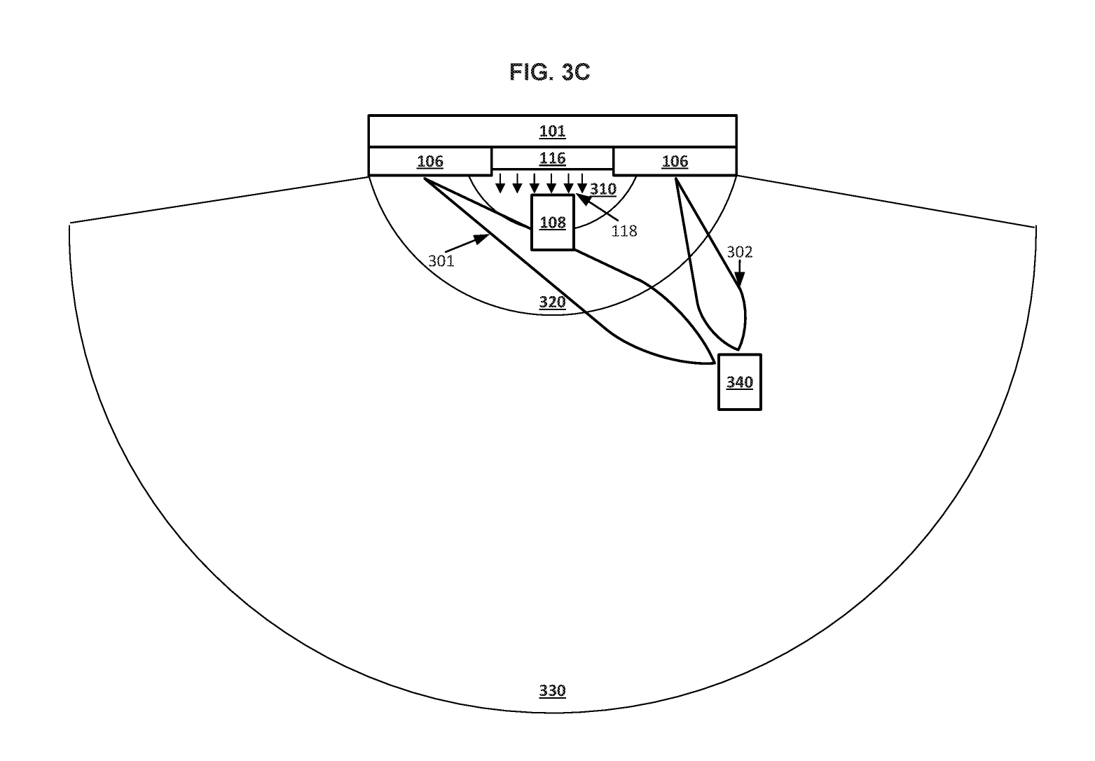

FIG. 3A shows an exemplary arrangement in accordance with the disclosed subject matter. The transmitter 101 may coordinate the transmission of wireless power by the sending transducer 106 and magnetic resonance transmitter 116. An area 310 may start in front of the magnetic resonance transmitter 116 and extend outward a specified distance from the magnetic resonance transmitter 116. The area 310 may be an area over which the magnetic resonance transmitter 116 can provide power to a receiver, such as the receiver 108, and may also be an area over which the sending transducer 106 cannot provide power to a receiver such as the receiver 108. An area 320 may be start at the outer edge of the area 310, and may extend outward a specified distance. The area 310 may be an area over which the magnetic resonance transmitter 116 can provide power to a receiver, such as the receiver 108, and may also be an area over which the sending transducer 106 can provide power to a receiver such as the receiver 108. An area 330 may be start at the outer edge of the area 320, and may extend outward a specified distance. The area 330 may be an area over which the magnetic resonance transmitter 116 cannot provide power to a receiver, such as the receiver 108, and may also be an area over which the sending transducer 106 can provide power to a receiver such as the receiver 108.

The receiver 108 may be located in the area 330, and may be the only receiver detected by the transmitter 101. The receiver 108 may be too far from the magnetic resonance transmitter 116 to receiver power from the oscillating magnetic field 118. With no other receivers in the area 310 or the area 320, the magnetic resonance transmitter 116 may be deactivated. The transmitter 101 may use the sending transducer 106 to generate the ultrasonic waves 107, for example, in the form of ultrasonic beams 301 and 302 from separate apertures of the sending transducer 106, which may be targeted at the receiving transducer 109 of the receiver 108. As the receiver 108 moves around the area 330, for example, being carried by a person, the transmitter 101 may track the location of the receiver 108 and orientation of the sending transducer 106 in any suitable manner, and the transmitter controller 105 may cause the sending transducer 106 to steer the ultrasonic beams 301 and 302 to maintain power delivery to the receiving transducer 109 as long as there is a line-of-sight available between any of the ultrasonic transducers of the sending transducer 106 and any of the ultrasonic transducers of the receiving transducer 109.

FIG. 3B shows an exemplary arrangement in accordance with the disclosed subject matter. The receiver 108 may be located in the area 320. For example, the receiver 108 may be moved by a person from the area 330 into the area 320. The transmitter 101 may determine that the receiver 108, and magnetic resonance receiver 117, may be close enough to the magnetic resonance transmitter 116 for the magnetic resonance receiver 117 to have current induced in its wire coils by the oscillating magnetic field 118. The transmitter controller 105 may cause power to be supplied to the magnetic resonance transmitter 116, which may generate the oscillating magnetic field 118. The receiver 108 may communicate power data to the transmitter 101, which may determine how much power to supply to the receiver 108 using the sending transducer 106. For example, the sending transducer 106 may be able to reduce the amount of power supplied to the receiver 108 using the sending transducer 106 due to the power being supplied to the receiver 108 by the magnetic resonance transmitter 117. The transmitter controller 105 may cause the sending transducer 106 to redirect the ultrasonic beam 302, for example, to supply power to a receiver 340 which may be in the area 330. The transmitter controller 105 may also cause the sending transducer 106 to reduce the power supplied to the receiver 108 through the ultrasonic beam 301, for example, reducing the number of ultrasonic transducers used to generate the ultrasonic beam 301.

FIG. 3C shows an exemplary arrangement in accordance with the disclosed subject matter. The receiver 108 may be located in the area 310. For example, the receiver 108 may be moved by a person from the area 320 into the area 310. The transmitter 101 may determine that the receiver 108, and magnetic resonance receiver 117, may be close enough to the magnetic resonance transmitter 116 for the magnetic resonance receiver 117 to have current induced in its wire coils by the oscillating magnetic field 118. The transmitter controller 105 may cause power to be supplied to the magnetic resonance transmitter 116, which may generate the oscillating magnetic field 118. The transmitter 101 may determine that the sending transducer 106 cannot deliver power to the receiver 108, for example, due to the receiving transducer 109 being at an oblique angle to the sending transducer 106. The receiver 108 may communicate power data to the transmitter 101, which may determine if the power supplied to the receiver 108 through the magnetic resonance transmitter 117 needs to be increased to compensate for lack of power from the sending transducer 106.

As the receiver 108 moves away from the transmitter 101 and the magnetic resonance transmitter 116, the transmitter controller 105 may reverse the changes made to wireless power delivery as the receiver 108 was moving closer to the transmitter 101. For example, when the receiver 108 moves from the area 310 to the area 320, the transmitter controller 105 may cause the sending transducer 106 to being sending power to the receiver 108 again, for example, redirecting the ultrasonic beam 301 away from the receiver 340 and back to the receiver 108. When the receiver 108 moves from the area 320 to the area 330, the transmitter 101 may reduce the power supply to the magnetic resonance transmitter 116, which may no longer generate the oscillating magnetic field 118 as the magnetic resonance receiver 117 may be out of range. The transmitter 101 may also increase the power supplied to the receiver 108 by the sending transducer 106.

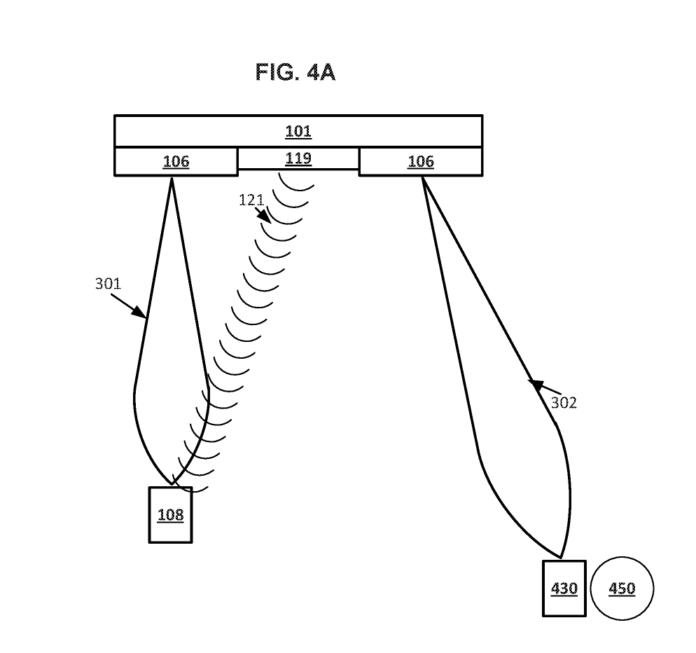

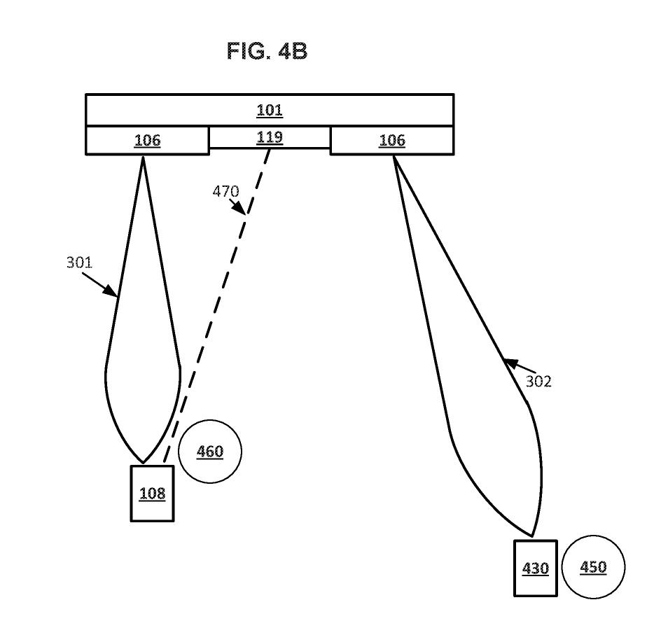

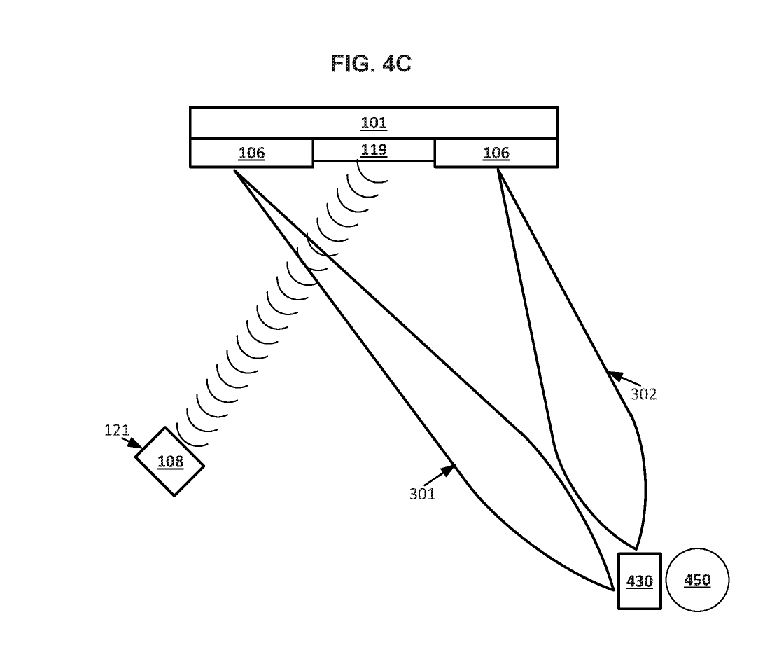

FIG. 4A shows an exemplary arrangement in accordance with the disclosed subject matter. The transmitter 101 may coordinate the transmission of wireless power by the sending transducer 106 and the infrared laser transmitter 119. The transmitter 101 may determine that there is a clear line-of-sight between the infrared laser transmitter 119 and the photo-voltaic receiver 120 of the receiver 108, with no people or animals proximate to the line-of-sight. The transmitter controller 105 may cause the infrared laser transmitter 119 to generate the beam of infrared light 121 targeted at the photo-voltaic receiver 120 of the receiver 108. The receiver 108 may communicate power data to the transmitter 101, which may determine how much power to supply to the receiver 108 using the sending transducer 106. For example, the sending transducer 106 may be able to reduce the amount of power supplied to the receiver 108 using the sending transducer 106 due to the power being supplied to the receiver 108 by the infrared laser transmitter 119. The transmitter controller 105 may cause the sending transducer 106 to redirect the ultrasonic beam 301, or may cause the sending transducer 106 to reduce the power supplied to the receiver 108 through the ultrasonic beam 301, for example, reducing the number of ultrasonic transducers used to generate the ultrasonic beam 301.

The transmitter 101 may determine that there is no clear line-of-sight between the infrared laser transmitter 119 and a photo-voltaic receiver of a receiver 430 without a proximate person or animal due to the presence of a person 450 near the receiver 430. The transmitter controller 105 may cause the sending transducer 106 to send power to the receiver 430, for example, generating the ultrasonic beam 302 and targeting the receiving transducer of the receiver 430.

FIG. 4B shows an exemplary arrangement in accordance with the disclosed subject matter. The transmitter 101 may determine that a person 460 has moved proximate to the line-of-sight 470 between the infrared laser transmitter 119 and the receiver 108. The transmitter 101 may reduce or remove the power supplied to the infrared laser transmitter 119, and the transmitter controller 105 may cause the infrared laser transmitter 119 to stop generating the beam of infrared light 121. The transmitter controller 105 may also cause the sending transducer 106 to increase the amount of power delivered to the receiver 108.

FIG. 4C shows an exemplary arrangement in accordance with the disclosed subject matter. The transmitter 101 may determine that there is a clear line-of-sight between the infrared laser transmitter 119 and the photo-voltaic receiver 120 of the receiver 108, and there are no people or animal proximate to the line-of-sight. The transmitter controller 105 may cause the infrared laser transmitter 119 to generate the beam of infrared light 121 targeted at the photo-voltaic receiver 120 of the receiver 108. The transmitter 101 may determine that the sending transducer 106 cannot deliver power to the receiver 108, for example, due to the receiving transducer 109 being at an oblique angle to the sending transducer 106. The receiver 108 may communicate power data to the transmitter 101, which may determine if the power supplied to the receiver 108 through the infrared laser transmitter 119 needs to be increased to compensate for the lack of power from the sending transducer 106. The transmitter controller 105 may cause the sending transducer 106 to redirect the ultrasonic beam 301 to another receiver, such as the receiver 430.

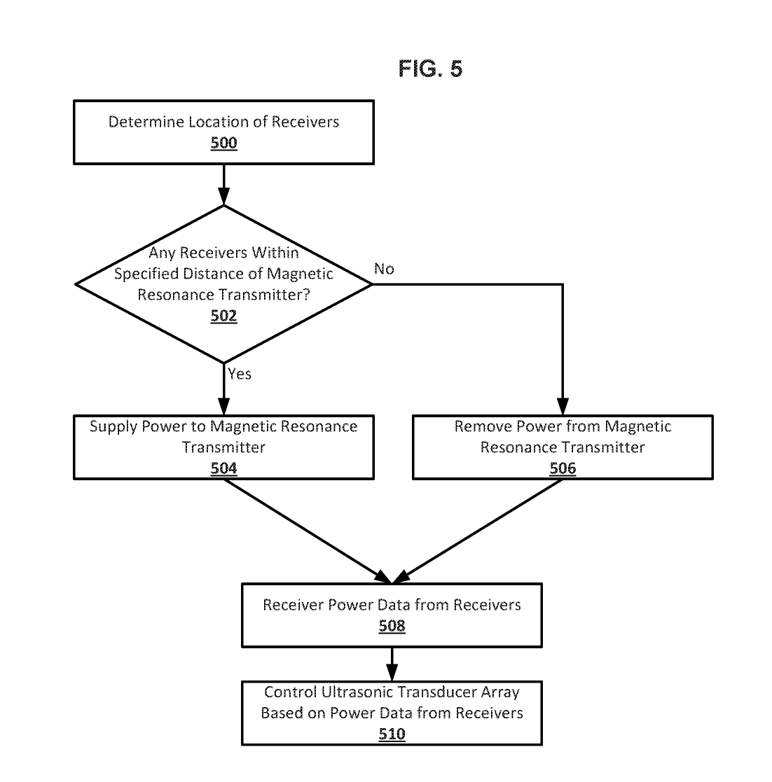

FIG. 5 shows an exemplary procedure in accordance with the disclosed subject matter. At 500, the location of receiver may be determined. For example, the transmitter 101 may determine the location of receivers such as the receiver 108 in any suitable manner. The transmitter 101 may, for example, receive location and orientation data from receivers, and may use, for example, camera, radar, Lidar, ultrasonic object tracking, or any other suitable object tracking, to determine the location and orientation of receivers.

At 502, the transmitter 101 may determine if there are any receivers within a specified distance of a magnetic resonance transmitter. For example, the transmitter 101 may include the magnetic resonance transmitter 116, which may have a range over which it can deliver wireless power to a magnetic resonance receiver. If any receivers with magnetic resonance receivers are within the specified distance of the transmitter 101, putting them in the range of the magnetic resonance transmitter 116, flow may proceed to 504. Otherwise, if there are no receivers with magnetic resonance receivers within the specified distance of the magnetic resonance transmitter 116, flow may proceed to 506.

At 504, power may be supplied to the magnetic resonance transmitter. For example, the transmitter 101, having determined that there is a receiver, for example, the receiver 108, within the specified distance of the magnetic resonance transmitter 116, may supply power to the magnetic resonance transmitter 116 to cause the generation, or increase in strength of, the oscillating magnetic field 118. The transmitter controller 105 may, for example, activate the magnetic resonance transmitter 116 and control the oscillation of the oscillating magnetic field 118 in order to achieve resonance between the wire coils of the magnetic resonance transmitter 116 and the wire coils of the magnetic resonance receiver 117.

At 506, power may be removed from the magnetic resonance transmitter. For example, the transmitter 101, having determined that there is no receiver within the specified distance of the magnetic resonance transmitter 116, may remove power from the magnetic resonance transmitter 116 to cause the cessation, or decrease in strength of, the oscillating magnetic field 118, or the deactivation of the magnetic resonance transmitter 116. If the magnetic resonance transmitter 116 was not yet active, it may remain inactive.

At 508, power data may be received from receivers. For example, the transmitter 101 may receive power data from receivers in its vicinity, such as the receiver 108. The power data from the receiver 108 may indicate the amount of power the receiver 108 is receiving from the transmitter 101 through the receiving transducer 109 and the magnetic power receiver 117, and a power requirement for the receiver 108, which may be an amount of power the receiver 108 wishes to receive. The transmitter 101 may receiver power data from receivers to which the transmitter 101 is not currently supplying power through either the sending transducer 106 or the magnetic resonance transmitter 116.

At 510, an ultrasonic transducer array may be controlled based on the power data from the receivers. For example, the transmitter controller 105 may control the sending transducer 106 of the transmitter 101 based on power data received from receivers, including, for example, the receiver 108. For example, the power data for the receiver 108 may indicate that the receiver 108 is generating power with both the magnetic resonance receiver 117 and the receiving transducer 109, and the total generated power is greater than the power requirement of the receiver 108. The transmitter controller 105 may reduce the amount of power being sent to the receiver 108 by the sending transducer 105, for example, turning off ultrasonic transducers, reducing the amplitude of the ultrasonic waves 107 directed at the receiver 108, redirecting an ultrasonic beam away from the receiver 108 towards another receiver which requires more power, or reducing the dwell time of an ultrasonic beam on the receiver 108. If no receivers are receiving power from the magnetic resonance transmitter 116, the transmitter controller 105 may use the sending transducer 106 to supply power to any receivers with a receiver transducer that has a line-of-sight to the sending transducer 106, and may divide power among multiple receivers in any suitable manner.

The transmitter 101 may loop back to 500 and again determine the locations of the receivers. This may include determining that some receivers have left the vicinity of the transmitter 101 and are no longer detectable by or in communication with the transmitter 101, and that new receivers have entered the vicinity of the transmitter 101. The transmitter 101 may continually determine the location of receivers and whether any receivers are within the specified distance of the magnetic resonance transmitter, receive power data from receivers, activate and deactivate the magnetic resonance transmitter and control the ultrasonic transducer array, the sending transducer 106, based on the power data, in order to coordinate wireless power transfer to the receivers using both the magnetic resonance transmitter 116 and the sending transducer 106.

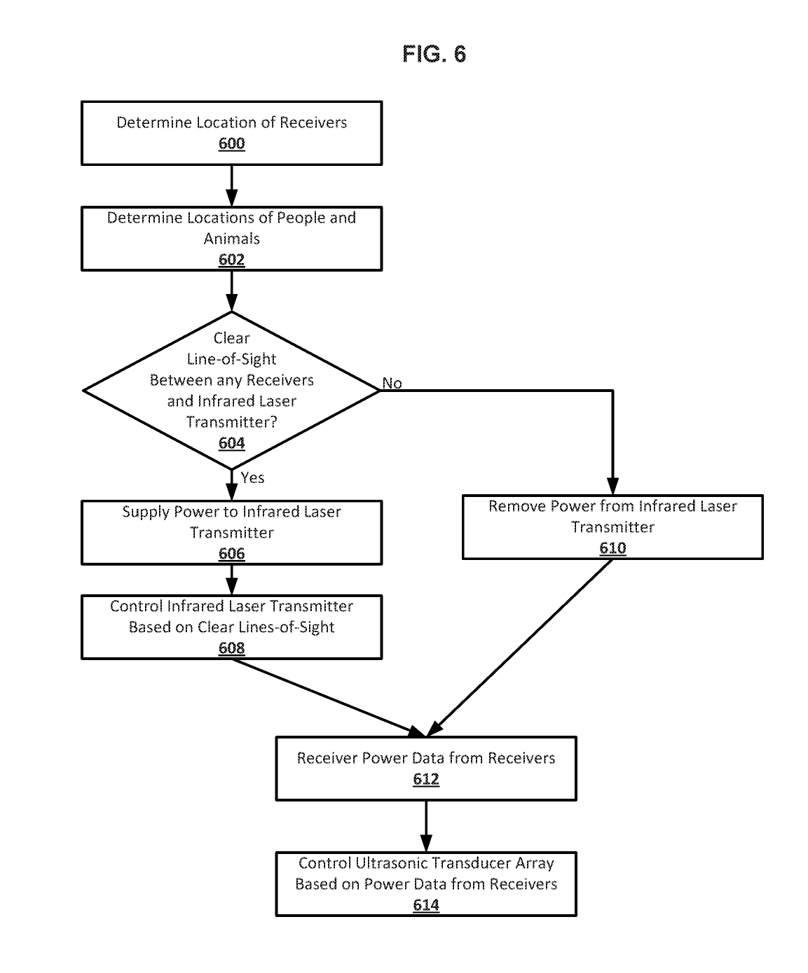

FIG. 6 shows an exemplary procedure in accordance with the disclosed subject matter. At 600, the location of receiver may be determined. For example, the transmitter 101 may determine the location of receivers such as the receiver 108 in any suitable manner. The transmitter 101 may, for example, receive location and orientation data from receivers, and may use, for example, camera, radar, Lidar, ultrasonic object tracking, or any other suitable object tracking, to determine the location and orientation of receivers.

At 602, the location of people and animals may be determined. For example, the transmitter 101 may determine the location of people and animals in any suitable manner. The transmitter 101 may, for example, use camera, radar, Lidar, ultrasonic object tracking, or any other suitable object tracking, to determine the location of people and animals.

At 604, the transmitter 101 may determine if there is a clear line-of-sight between any receivers and an infrared laser transmitter. For example, the transmitter 101 may include the infrared laser transmitter 119, which may only be able to deliver power to a receiver if there is a clear line-of-sight to the photo-voltaic receiver of that receiver, with no people or animals proximate to the line-of-sight. If there is a clear line-of-sight from the infrared laser transmitter 119 to the photo-voltaic receiver of any receiver, flow may proceed to 606. Otherwise, if there are not clear lines-of-sight to any photo-voltaic receiver of any receiver, flow may proceed to 610.

At 606, power may be supplied to the infrared laser transmitter. For example, the transmitter 101, having determined that there is a receiver, for example, the receiver 108, with a photo-voltaic receiver with a clear line-of-sight to the infrared laser transmitter 119, may supply power to the infrared laser transmitter 119 to cause the generation of the beam of infrared light 121. The transmitter controller 105 may, for example, activate the infrared laser transmitter 119 if it was inactive, or the transmitter 101 may continue to supply power to the infrared laser transmitter 119 if it was active.

At 608, the infrared laser transmitter may be controlled based on clear lines-of-sight. For example, the transmitter controller 105 may cause the infrared laser transmitter 119 to target the photo-voltaic receivers of any receiver that was determined to have a clear of line-of-sight to the infrared laser transmitter 119 with a beam of infrared light, such as the beam of infrared light 121. If there are multiple receivers with clear lines-of-sight, the infrared laser transmitter 119 may generate multiple beams of infrared light, for example, using different infrared lasers, or may cause a single beam of infrared light to switch targets. For example, the beam of infrared light 121 may be targeted at the photo-voltaic receiver 120 of the receiver 108 for a period of time, may be turned off, re-targeted to the photo-voltaic receiver of a different receiver, turned back on for a period of time, and then turned off before being re-targeted, for example, back at the photo-voltaic receiver 120 of the receiver 108 or at another receiver with a clear line-of-sight.

At 610, power may be removed from the infrared laser transmitter. For example, the transmitter 101, may have determined that there is no clear line-of-sight from the infrared laser transmitter 119 to the photo-voltaic receiver of any receiver. For example, a person or animal may have moved proximate to a previously clear line-of-sight, an object may have obstructed a previously clear line-of-sight, a receiver with a previously clear line-of-sight may have moved, or there may have been no previously clear line-of-sight. The transmitter 101 may remove power from the infrared laser transmitter 119, and the transmitter controller 105 may cause the infrared laser transmitter 119 to turn off the infrared lasers, ceasing the generation of the beam of infrared light 121 if it was being generated, or causing the infrared lasers to remain off if they were already off.

At 612, power data may be received from receivers. For example, the transmitter 101 may receive power data from receivers in its vicinity, such as the receiver 108. The power data from the receiver 108 may indicate the amount of power the receiver 108 is receiving from the transmitter 101 through the receiving transducer 109 and the photo-voltaic receiver 120, and a power requirement for the receiver 108, which may be an amount of power the receiver 108 wishes to receive. The transmitter 101 may receiver power data from receivers to which the transmitter 101 is not currently supplying power through either the sending transducer 106 or the infrared laser transmitter 119.

At 614, an ultrasonic transducer array may be controlled based on the power data from the receivers. For example, the transmitter controller 105 may control the sending transducer 106 of the transmitter 101 based on power data received from receivers, including, for example, the receiver 108. For example, the power data for the receiver 108 may indicate that the receiver 108 is receiving power through both the photo-voltaic receiver 120 and the receiving transducer 109, and the total received power is greater than the power requirement of the receiver 108. The transmitter controller 105 may reduce the amount of power being sent to the receiver 108 by the sending transducer 105, for example, turning off ultrasonic transducers, reducing the amplitude of the ultrasonic waves 107 directed at the receiver 108, redirecting an ultrasonic beam away from the receiver 108 towards another receiver which requires more power, or reducing the dwell time of an ultrasonic beam on the receiver 108. If no receivers are receiving power from the infrared laser transmitter 119, the transmitter controller 105 may use the sending transducer 106 to supply power to any receivers with a receiver transducer that has a line-of-sight to the sending transducer 106, and may divide power among multiple receivers in any suitable manner.

The transmitter 101 may loop back to 600 and again determine the locations of the receivers. This may include determining that some receivers have left the vicinity of the transmitter 101 and are no longer detectable by or in communication with the transmitter 101, and that new receivers have entered the vicinity of the transmitter 101. The transmitter 101 may also again determine the location of people and animals. The transmitter 101 may continually determine the location of receivers, people, and animals, and whether there is a clear line-of-sight to any photo-voltaic receiver from the infrared laser transmitter 119, control the infrared laser transmitter 119, receive power data from receivers, and control its ultrasonic transducer array, the sending transducer 106, based on the power data, in order to coordinate wireless power transfer to the receivers using both the infrared laser transmitter 119 and the sending transducer 106.

In accordance with embodiments of the present invention, a given device may act as essentially as a relay between an initial transmitter and a terminal receiver device. Such a device (a “relay device” or an “intermediate device”) may receive power from a first device, convert at least a part of the received power to electrical energy, re-convert it to acoustic energy and then beam that acoustic energy to the terminal receiver device. This can be useful when the terminal device may be out of range of the initial transmitter device, especially when the initial transmitter device stores a substantial amount of energy or is connected to a larger source of energy, such as an electrical outlet or a large external battery. This can also be used to arrange for a transfer energy from a device that has sufficient or an excess amount of stored energy to a device in need of energy, even when the latter may be out of range of the former without a relay or intermediate device.

The mobile application may also inform the user of how quickly its mobile application device is being charged and how much more power and/or time the device requires until it's fully charged. Additionally, the mobile application can indicate the user's “burn rate” based on the amount of data being used on the device at a given time based on a variety of factors, for example, how many programs/applications are open and can indicate that the device will need to charge again in a given time period. The mobile application may tell the user when the device is using power from the device battery or power from the wireless power system. For example, the mobile application may have a hard or soft switch to signal the transmitter when the device battery is less than 20% full, thereby reducing the use of dirty energy and allowing the system to supply the most power to those who need it to the most. Additionally, the user may have the ability to turn off their ultrasonic receptor and/or transmitter using the mobile application.

At least part of the receiver 108 may be in the shape of a protective case, cover, or backing for a device, such as a cell phone, that may be inside or outside the physical device. An energy storage device, such as a rechargeable battery, may be embedded within the receiver case. The receiver 108 may also be used in other devices such as a laptop, tablet, or digital reader, for example in a case or backing therefor. The receiver 108 may be embedded within the electronic housing or can be a physical attachment. The receiver 108 can be any shape or size and can function as an isolated power receiver or be connected to a number of devices to power them simultaneously or otherwise.

In an embodiment of the disclosed subject matter, the receiver 108 can be a medical device such as an implant, for example a pacemaker, or drug delivery system. The implant can be powered, or the storage device can be charged, using an ultrasonic transmitter 101. The characteristics of the transmitter 101 and/or receiver 108 can be tuned taking into account the power needs of the device, the conduction parameters of the tissue between the transmitter 101 and receiver 108, and the needs of the patient. For ultrasonic power transmission through animal or plant tissue, the receiver 108 can be embedded in a medical device and/or tissue to power or charge a chemical deliver or medical device such as an implanted device. For example, a transmitter 101 could be programmed to emit ultrasound waves at a given time to a receiver 108 located within a pacemaker device implanted in the body of a patient.

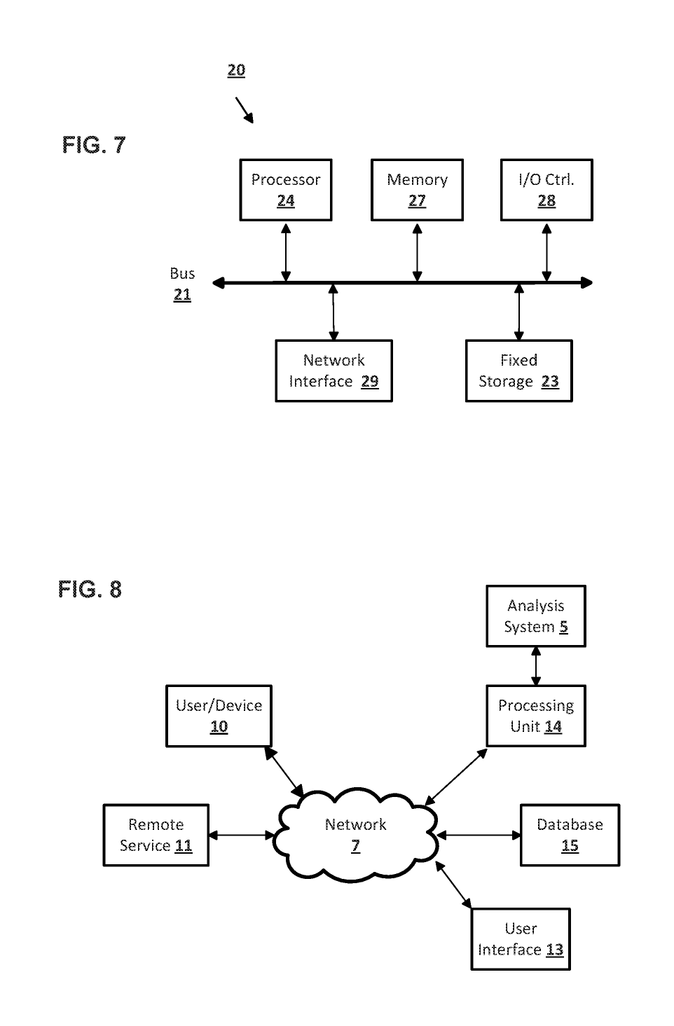

In some implementations, the sending transducer 106 may be designed to deliver a relatively uniform pressure to a rectangle such as a surface of, on or in a mobile device. For example, an embodiment can be designed to deliver acoustic energy to a mobile device such as a smartphone of size 115×58 mm at a distance of one meter from the transmitter with a transmit frequency in the range of 40-60 kHz (i.e. the wavelength can be 5.7 to 8.5 mm.) Embodiments of the presently disclosed subject matter may be implemented in and used with a variety of component and network architectures. FIG. 7 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 8.

Many other devices or components (not shown) may be connected in a similar manner, such as document scanners, digital cameras, auxiliary, supplemental, or backup systems, or the like. Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 8 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A system, comprising:
a transmitter device comprising:
a first transmitter wireless power transfer device that uses a first type of wireless power transfer;
a second transmitter wireless power transfer device that uses a second type of wireless power transfer different from the first type of wireless power transfer; and
a controller coupled to the first transmitter wireless power transfer device and the second transmitter wireless power transfer device that controls the transmission of wireless power from the first wireless power transfer device and the second wireless power transfer device;
and
a receiver device comprising:
a first receiver wireless power transfer device that uses the first type of wireless power transfer and generates a first electrical signal based on a transfer of wireless power using the first type of wireless power transfer from the first transmitter wireless power transfer device;
a second receiver wireless power transfer device that uses the second type of wireless power transfer and generates a second electrical signal based on a transfer of wireless power using the second type of wireless power transfer from the second transmitter wireless power transfer device; and
a receiver electrical storage device that stores electrical energy based on the first electrical signal generated by the first receiver wireless power transfer device and the second electrical signal generated by the second wireless power transfer device.

2. The system of claim 1, wherein the first transmitter wireless power transfer device is a first ultrasonic transducer array and the first receiver wireless power transfer device is a second ultrasonic transducer array.

3. The system of claim 2, wherein the second transmitter wireless power transfer device is a magnetic resonance transmitter and the second receiver wireless power transfer device is a magnetic resonance receiver.

4. The system of claim 3, wherein the controller activates the magnetic resonance transmitter in response to a determination by the transmitter device that the receiver device is within a specified distance of the transmitter device.

5. The system of claim 4, wherein the controller causes the first ultrasonic transducer array to reduce an amount of power transmitted to the second ultrasonic transducer array while the magnetic resonance transmitter is active.

6. The system of claim 5, wherein the controller causes the first ultrasonic transducer array to increase the amount of power transmitted to the second ultrasonic transducer array and deactivates the magnetic resonance transmitter in response to a determination by the transmitter device that the receiver device is no longer within the specified distance of the transmitter device.

7. The system of claim 2, wherein the second transmitter wireless power transfer device is an infrared laser transmitter and the second receiver wireless power transfer device is a photo-voltaic receiver.

8. The system of claim 7, wherein the controller activates the infrared laser transmitter in response to a determination by the transmitter device that there is a clear line-of-sight between at least one infrared laser of the infrared laser transmitter and at least a portion of the photo-voltaic receiver.

9. The system of claim 8, wherein the controller causes the first ultrasonic transducer array to reduce an amount of power transmitted to the second ultrasonic transducer array while the infrared laser transmitter is active.

10. The system of claim 9, wherein the controller causes the first ultrasonic transducer array to increase the amount of power transmitted to the second ultrasonic transducer array and deactivates the infrared laser transmitter in response to a determination by the transmitter device that there is no clear line-of-sight between any infrared laser of the infrared laser transmitter and any portion of the photo-voltaic receiver.

11. A method for wireless power transfer comprising:
determining a location of a receiver device;
transmitting wireless power to the receiver device using one or both of a first wireless power transfer device and a second wireless power device based on the location of the receiver, wherein the first wireless power transfer device uses a first type of wireless power transfer and the second wireless power transfer device uses a second type of wireless power transfer; and
adjusting an amount of power transmitted to the receiver device by the first wireless power transfer device using the first type of wireless power transfer based on an amount of power transmitted to the receiver by the second wireless power transfer device using the second type of wireless power transfer.

12. The method of claim 11, wherein the first wireless power transfer device is an ultrasonic transducer array.

13. The method of claim 12, wherein the second wireless power transfer device is a magnetic resonance transmitter, and wherein transmitting wireless power to the receiver device using one or both of the first wireless power transfer device and the second wireless power device based on the location of the receiver further comprises:
determining based on the location of the receiver device that the receiver device is within a specified distance of the magnetic resonance transmitter; and
activating the magnetic resonance transmitter.

14. The method of claim 13, further comprising:
determining based on a second location of the receiver device that the receiver device is no longer within the specified distance of the magnetic resonance transmitter; and
deactivating the magnetic resonance transmitter.

15. The method of claim 12, wherein the second wireless power transfer device is an infrared laser transmitter, and wherein transmitting wireless power to the receiver device using one or both of the first wireless power transfer device and the second wireless power device based on the location of the receiver further comprises:
determining that there is clear line-of-sight from an infrared laser of the infrared laser transmitter to at least a portion of a photo-voltaic receiver of the receiver device based partially on the location of the receiver device;
activating the infrared laser transmitter; and
targeting a beam of infrared light generated by the infrared laser transmitter at the at least a portion of the photo-voltaic receiver to which there is a clear line-of-sight.

16. The method of claim 15, further comprising:
determining that there is no longer a clear line-of-sight to any portion of the photo-voltaic device of the receiver device; and
deactivating the infrared laser transmitter or targeting the beam of infrared light at another photo-voltaic device of another receiver device.

17. The method of claim 11, wherein adjusting the amount of power transmitted to the receiver device by the first wireless power transfer device using the first type of wireless power transfer based on the amount of power transmitted to the receiver by the second wireless power transfer device using the second type of wireless power transfer further comprises:
receiving power data from the receiver device; and
determining an amount of power by which to reduce the amount of power transmitted to the receiver device by the first wireless power transfer device using the first type of wireless power transfer based on the power data.

18. The method of claim 17, wherein the power data comprises a power requirement of the receiver device and one or both of the amount of power the receiver device is receiving from the first wireless power transfer device using the first type of wireless power transfer and the amount of power the receiver device is receiving from the second wireless power transfer device using the second type of wireless power transfer.

19. The method of claim 18, wherein the amount of power by which the amount of power transmitted to the receiver device by the first wireless power transfer device using the first type of wireless power transfer based on the power data is reduced comprises at most the difference between the power requirement of the receiver device and the sum of the amount of power the receiver device is receiving from the first wireless power transfer device using the first type of wireless power transfer and the amount of power the receiver device is receiving from the second wireless power transfer device using the second type of wireless power transfer.

20. A method for wireless power transfer comprising:
determining locations of a plurality of receiver devices;
determining, based on the locations of the plurality of receiver devices, whether at least one receiver device is within a specified distance of a magnetic resonance transmitter;
controlling the magnetic resonance transmitter to generate an oscillating magnetic field when there is as at least one receiver device within the specified distance of the magnetic resonance transmitter and to not generate the oscillating magnetic field when there are no receiver devices within the specified distance of the magnetic resonance transmitter;
receiving power data from one or more of the plurality of receiver devices;
controlling an ultrasonic transducer array to generate one or more ultrasound beams targeted to at least one of the plurality of receiver devices based on the received power data.

21. The method of claim 20, wherein the specified distance comprises a range over which the magnetic resonance transmitter can transmit wireless power using the oscillating magnetic field.

22. The method of claim 20, wherein the power data from one of the one or more of the plurality of receiver devices comprises a power requirement for the receiver device.

23. The method of claim 22, further comprising controlling the ultrasonic transducer array to generate the one or more ultrasound beams targeted to at least one of the plurality of receiver devices based on power requirements in the power data for one or more of the receiver devices.

24. A method for wireless power transfer comprising
determining whether there is a clear line-of-sight between any infrared laser of an infrared transmitter and any portion of a photo-voltaic receiver of any of one or more receiver devices;
controlling the infrared laser transmitter to generate at least one beam of infrared light when there is as at least one infrared laser with a clear line-of-sight to a portion of a photo-voltaic receiver of a receiver device of the one or more receiver devices, wherein the at least one beam of infrared light is generated using the infrared laser with the clear line-of-sight and is targeted at the portion of the photo-voltaic receiver to which the infrared laser has a clear line-of-sight, and to not generate any beam of infrared light when there are no clear lines-of-sight between any infrared laser and any portion of a photo-voltaic receiver of any of the one or more receiver devices;
receiving power data from one or more of the receiver devices;
controlling an ultrasonic transducer array to generate one or more ultrasound beams targeted to at least one of the receiver devices based on the received power data.

25. The method of claim 20, wherein a clear line-of-sight comprises a line-of-sight with no obstruction in the line-of-sight and with no people or animals proximate to the line-of-sight.

26. The method of claim 20, wherein the power data from a receiver device of the one or more receiver devices comprises a power requirement for the receiver device.

27. The method of claim 22, further comprising controlling the ultrasonic transducer array to generate the one or more ultrasound beams targeted to at least one of the receiver devices based on the received power data based on power requirements in the power data for one or more of the receiver devices.

28. A transmitter device comprising:
a first wireless power transfer device that uses a first type of wireless power transfer;
a second wireless power transfer device that uses a second type of wireless power transfer different from the first type of wireless power transfer; and
a controller coupled to the first wireless power transfer device and the second wireless power transfer device that controls the transmission of wireless power from the first wireless power transfer device and the second wireless power transfer device;

29. The device of claim 28, wherein the first wireless power transfer device is an ultrasonic transducer array.

30. The device of claim 29, wherein the second wireless power transfer device is a magnetic resonance transmitter.

31. The device of claim 30, wherein the controller activates the magnetic resonance transmitter in response to a determination by the transmitter device that a receiver device with a magnetic resonance receiver is within a specified distance of the transmitter device.

32. The system of claim 31, wherein the controller causes the ultrasonic transducer array to reduce an amount of power transmitted to an ultrasonic transducer array of the receiver device while the magnetic resonance transmitter is active.

33. The system of claim 32, wherein the controller causes the ultrasonic transducer array to increase the amount of power transmitted to the ultrasonic transducer array of the receiver device and deactivates the magnetic resonance transmitter in response to a determination by the transmitter device that the receiver device is no longer within the specified distance of the transmitter device.

34. The system of claim 29, wherein the second wireless power transfer device is an infrared laser transmitter.

35. The system of claim 34, wherein the controller activates the infrared laser transmitter in response to a determination by the transmitter device that there is a clear line-of-sight between at least one infrared laser of the infrared laser transmitter and at least a portion of a photo-voltaic receiver of a receiver device.

36. The system of claim 35, wherein the controller causes the ultrasonic transducer array to reduce an amount of power transmitted to an ultrasonic transducer array of the receiver device while the infrared laser transmitter is active.

37. The system of claim 36, wherein the controller causes the ultrasonic transducer array to increase the amount of power transmitted to the ultrasonic transducer array of the receiver device and deactivates the infrared laser transmitter in response to a determination by the transmitter device that there is no clear line-of-sight between any infrared laser of the infrared laser transmitter and any portion of the photo-voltaic receiver.
